(19) United States
(12) Patent Application Publication
(10) Pub. No.: US 2005/0004903 A1
(43) Pub. Date: Jan. 6, 2005

(54) Regional information retrieving method and regional information retrieval apparatus

(75) Inventor: Hiroshi Tsuda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/896,067

(22) Filed: Jul. 22, 2004

Related U.S. Application Data
(63) Continuation of application No. PCT/JP02/02478, filed on Mar. 15, 2002.

(51) Int. Cl. G06F 7/00

(52) U.S. Cl. 707/3

(57) ABSTRACT

A Web regional information retrieval apparatus 10 retrieves a Web page which is information in the Worldwide Web (WWW), and includes a collecting unit 11, a regional meta-data extraction unit 12, and a region information retrieval unit 14. The collecting unit 11 collects a Web page from the WWW. The regional meta-data extraction unit 12 extracts regional meta-data indicating the region relating to the collected Web page, and assigns the data to the Web page. The region information retrieval unit 14 receives location information indicating the location of the terminal 20 from the terminal 20, retrieves a Web page assigned the regional meta-data related to the location information from the WWW, and transmits the retrieval result to the terminal 20.

### CROSS REFERENCE TO RELATED APPLICATION

This application is a continuation of international PCT application No. PCT/JP02/02478 filed on Mar. 15, 2002.

### BACKGROUND OF THE INVENTION

1. Field of the Invention

The present invention relates to a retrieval apparatus for retrieving information based on a region and location from a large volume of manifold documents, and more specifically to a preferred retrieval apparatus in a mobile environment.

2. Description of the Related Art

As it is estimated that there were more than 2 billion Web pages in 2000, a large volume of information is stored in the worldwide Web (WWW or simply Web). In addition, the information in the WWW is large not only in volume, but also in variation. To retrieve specified information in the WWW, it is important how the information is presented depending on the needs.

Furthermore, the method of accessing the WWW has changed from the conventional access using a desktop computer to the access using a mobile terminal, that is, the method has changed into a mobile environment.

In the above-mentioned mobile environment, there is a request for retrieval occurring for the information about the current location of a terminal, that is, a user, or for the information about the building seen by the user from the current location.

On the other hand, a retrieval service, retrieving the information in the WWW using a keyword received from a terminal has been conventionally presented. The conventional retrieval service is described below by referring to FIG. 1. As shown in FIG. 1, the user transmits a keyword from a terminal to a search engine over a network. The search engine retrieves information in the WWW such as the Internet, obtains the information matching the keyword, and transmits a list of URIs or URLs indicating the location of the obtained information in the WWW to the user.

However, in this technology, the retrieval result can include information other than that about the location that the user desires to obtain, or information about a different location having the same location name.

For example, assume that information retrieval is performed using the keyword “Kiyomizu” to check the information about the location named “Kiyomizu”. The retrieval result can include unnecessary information about a person named “Kiyomizu” in addition to the location called “Kiyomizu”. Furthermore, for example, assume that information retrieval is performed using the keyword “Fuchu City” to check the information about the city of Fuchu in Tokyo. The retrieval result can include unnecessary information about the city of Fuchu in Hiroshima Prefecture in addition to the information about the city of Fuchu in Tokyo.

Thus, when the obtained information includes unnecessary information, the user carefully checks the obtained information to correctly select necessary information. Therefore, the conventional retrieval service has been inconvenient for users.

Additionally, in the conventional technology, the same information can be obtained using the same keyword regardless of the attribute of a user or the current location of the user. For example, assume that information retrieval is performed using “souvenir shop” as a keyword, no “souvenir shop near the current location of the user” can be directly checked.

Recently, each mobile telephone company has started the service of providing a user with the information about the current location of the user. However, in this service, the information stored in a database is prepared by classifying data by region, and presented together with the GPS (global positioning system), etc. That is, no information in the WWW is retrieved. Therefore, there has been the problem that a database is to be prepared at a large cost, and constantly updated.

Furthermore, the “Semantic Web” has been proposed as the WWW of the next generation centering on the W3C (worldwide Web consortium). This indicates the trend to efficiently retrieve or integrate the information in the WWW by adding meta-data to the information in the WWW. The meta-data refers to various attribute information about data. The meta-data about information in the WWW and a service provided in the WWW can be, for example, an URL (uniform resource locator), a publisher, a category, an address, etc.

Since there are restrictions imposed on automated retrieval of the information having a specific attribute from manifold information in the WWW, it is considered that the utility of the information in the WWW can be remarkably enhanced if the Semantic Web can be realized. However, it is difficult to realize the Semantic Web because there is the problem who assigns a large volume of meta-data to a huge volume of the information in the WWW without a special merit.

### SUMMARY OF THE INVENTION

The first object of the present invention is to provide a retrieving technology for searching manifold information based on the location information about geographical locations, and enabling acquisition of the information about the location or place.

The second object of the present invention is to provide a supporting technology for adding meta-data which possibly promotes the addition of meta-data to a Web page.

To attain the above-mentioned objects, according to the first aspect of the present invention, the Web page retrieving method for retrieving a Web page which is information in the WWW includes extracting regional meta-data indicating a region relating to the Web page, adding the regional meta-data to the Web page, and retrieving the Web page to which the regional meta-data relating to the location information about the geographic location is added.

In the above-mentioned retrieving method, regional meta-data indicating the region relating to the Web page in the WWW is added, and the Web page relating to the location indicated by the location information is retrieved. Thus, the above-mentioned first object can be attained.

In the above-mentioned method, the regional meta-data can be extracted based on the representation of a region contained in the text of the Web page because the Web page is considered to relate to the region in the case that the representation of the region is contained in the text.

Furthermore, in the above-mentioned retrieving method, the regional meta-data can also be extracted based on the representation of the region contained in the text of a Web page which is the link destination of another Web page. For example, although the representation of the region is not included on the top page of the site, the representation of the region related to the site can be included in the text of the linked page which is linked from the top page of the site containing the character string such as “access destination”, etc. Therefore, when the representation of the region contained on the linked page is included, the Web page of the link source of the linked page can be considered to relate to the region.

In the above-mentioned retrieving method, the regional meta-data can be extracted according to the flag information about the location of the Web page in the WWW. The flag information can be a URI and a URL because a character string indicating the flag information can include a character string indicating the region related to the Web.

In the above-mentioned retrieving method, the regional meta-data can also be extracted based on the link relation between Web pages because, for example, when a number of linking pages which are the link sources of a Web page have regional meta-data indicating a region, the Web page which is the link destination of the linking page can also be considered to be a related region represented by the regional meta-data.

Furthermore, in the retrieving method, the regional meta-data can also be extracted based on the past retrieval result of the Web page because, for example, when a Web page is frequently accessed from a region, the Web page can be considered to relate to the region.

In the above-mentioned retrieving method, the retrieval results can be sorted according to the regional meta-data and the location information. To be more practical, a Web page referring to a region closer to the location indicated by the location information can be arranged closer to the leading page.

Furthermore, in the above-mentioned retrieving method, when the regional meta-data is added to the Web page by an author of a Web page, at least a part of the past retrieval results can be presented.

Thus, the author can obtain the information indicating from which source or how often a Web page is accessed, in return of the addition of regional meta-data to the Web page. Thus, the second object to promote the addition of meta-data by an author can be attained.

Additionally, in the above-mentioned retrieving method, when a Web page is generated or updated, a prospect for the regional meta-data to be added to the Web page can be extracted and transmitted to the author of the Web page.

Thus, the author of the Web page can easily add meta-data by selecting appropriate regional meta-data from among received prospects for regional meta-data. Thus, the second object can also be attained.

In the above-mentioned method, the advertisement information indicating the contents to be advertised and the regional meta-data relating to the advertisement information can be stored in the storage unit, the advertisement information containing the regional meta-data relating to the location information can be obtained from the storage unit, and the obtained advertisement information can be transmitted to the terminal which transmitted the location information. Thus, the advertisement relating to the location and indicated by the location information can be transmitted to the terminal, thereby more effectively advertising to the user of a terminal.

According to another aspect of the present invention, the method for supporting the addition of meta-data to a Web page includes: extracting a candidate for regional meta-data indicating a region relating to the Web page; and transmitting the candidate for the regional meta-data to the author of the Web page. Thus, the second object can be attained.

According to a further aspect of the present invention, the information arranging method includes: receiving information to be registered indicating the contents to be registered and location information indicating the location of a terminal; extracting regional meta-data indicating a region relating to the information to be registered; associating the information to be registered, the regional meta-data, and the location information with one another and storing the resultant information in the storage unit; and when a retrieval request is received, retrieving information to be registered corresponding to the regional meta-data relating to the retrieval request from the storage unit.

An apparatus configured to follow the procedure used in the method of the above-mentioned aspects of the present invention can attain the above-mentioned objects. A program used to direct a computer to use the procedure similar to that used in the method according to each aspect of the present invention can attain the object by allowing the computer to read and execute the program. Furthermore, the program can be read from a computer-readable storage medium and executed by the computer, thereby attaining the above-mentioned object.

### BRIEF DESCRIPTION OF THE DRAWINGS

FIG. 1 is an explanatory view showing the conventional service of retrieving;

FIG. 2 is an explanatory view showing the feature of the Web regional information arranging apparatus according to the first embodiment of the present invention;

FIG. 3 is a block diagram showing the function of the Web regional information retrieval apparatus according to the first embodiment of the present invention;

FIG. 4 shows an example of the data structure of the URI-ID table;

FIG. 5 shows an example of the data structure of the reference table;

FIG. 6 shows an example of the data structure of the region list table;

FIG. 7 shows an example of the data structure of the landmark knowledge table;

FIG. 8 shows an example of the data structure of a retrieval log;

FIG. 9 shows an example of the data structure of a popularity level table;

FIG. 10 shows an example of the data structure of the URI meta-data table;

FIG. 11 shows an example of the data structure of the regional meta-data table;

FIG. 12 shows an example of the data structure of the author-assigned meta-data table;

FIG. 13 shows an example of the data structure of the retrieval log total table;

FIG. 14 is an explanatory view showing the case in which regional meta-data is added to a Web page;

FIGS. 15A and 15B are explanatory views showing the case in which regional meta-data is stored in the meta-data file in which the regional meta-data is related to a Web page;

FIG. 16 shows a flow (main flow) of the entire process of extracting regional meta-data;

FIG. 17 is a flowchart showing the process of extracting regional meta-data from the text of a Web page;

FIG. 18 is a flowchart showing the process of extracting regional meta-data from meta-data added by the author to a Web page;

FIG. 19 is a flowchart showing the process of extracting regional meta-data from the retrieval log total table;

FIG. 20 is a flowchart showing the process of extracting regional meta-data from a Web page which is a link source of another Web page;

FIG. 21 is a flowchart showing the process of extracting regional meta-data from the character string indicating a URI;

FIG. 22 is an explanatory view showing the method of determining the priority relating to a region of a Web page;

FIG. 23 is a block diagram showing the function of the sightseeing portal site and the meta-data generation device relating to the second embodiment of the present invention;

FIG. 24 shows an example of the attribute of meta-data obtained by the meta-data generation device;

FIG. 25 shows an example of the attribute of the data contained in a user profile;

FIG. 26 is an explanatory view of the case in which a user retrieves information in the WWW using the sightseeing portal site before starting his or her trip;

FIGS. 27A through 27D are explanatory views showing the case in which a traveling user retrieves information in the WWW using a sightseeing portal site 40;

FIG. 28 is a block diagram showing the function of the regional information retrieval apparatus according to the third embodiment of the present invention;

FIG. 29 is an explanatory view showing the information advertisement distribution device depending on the location according to the fourth embodiment of the present invention;

FIG. 30 shows the structure of a computer; and

FIG. 31 is an explanatory view showing the storage medium and a transmission signal for providing data and a program for a computer.

### DESCRIPTION OF THE PREFERRED EMBODIMENTS

The embodiments of the present invention are described below by referring to the attached drawings.

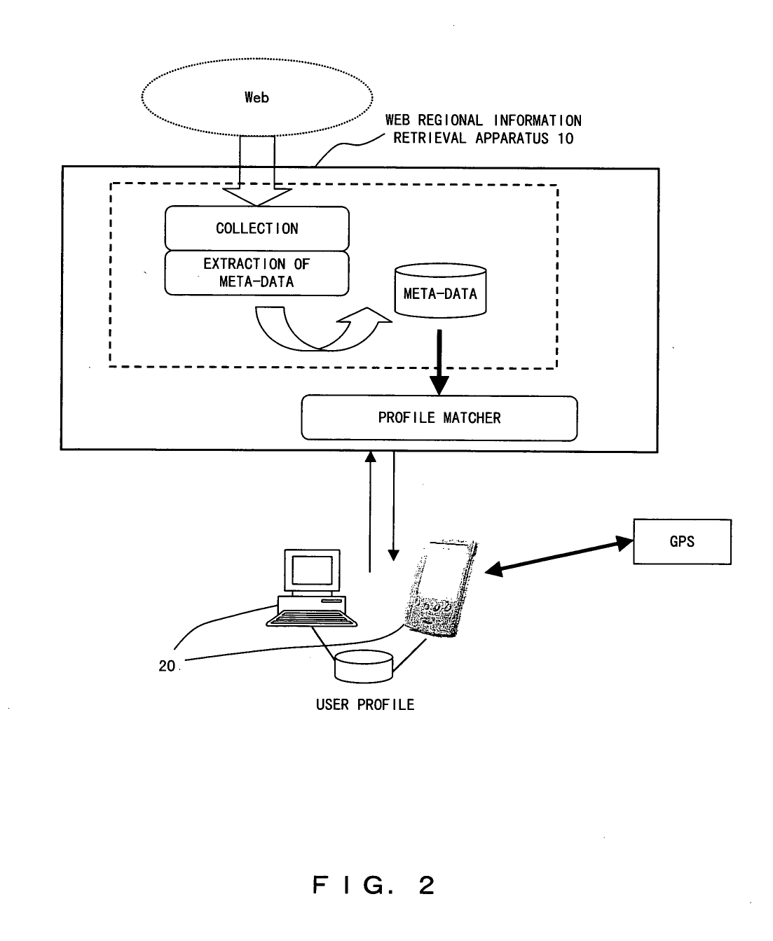

FIG. 2 shows the characteristic of the Web regional information retrieval apparatus according to the first embodiment of the present invention.

A Web regional information retrieval apparatus 10 according to the first embodiment of the present invention is connected to the WWW and a terminal 20 of a user over a network (not shown in the attached drawings).

The terminal 20 of a user can be a desktop computer or a PDA (personal digital assistance) such as a mobile telephone.

The Web regional information retrieval apparatus 10 collects information in the WWW, adds meta-data indicating which region the information relates to, associates the meta-data to the collected information, and stores them together.

The terminal 20 comprises storage unit (not shown in the attached drawings) storing the location information indicating the geographical location when the computer is a desktop computer. When terminal 20 is a PDA, terminal 20 obtains the location information indicating the location information indicating the geographical location of terminal 20 using the radio technology represented by the GPS and Bluetooth (registered trademark).

When a user wants to check the current location of the user, he or she transmits his or her keyword and the location information to the Web regional information retrieval apparatus 10 through the terminal 20. The Web regional information retrieval apparatus 10 searches the database according to the keyword and the location information, and transmits the information obtained as a result of the search as the information about the region indicated by the location information. Thus, the information about the current location of the user can be provided for the user.

Furthermore, the terminal 20 of the user can also comprise a database storing a user profile which is the information about the user. In this case, the terminal 20 transmits a user profile to the Web regional information retrieval apparatus 10 in addition to the keyword and the location information. The Web regional information retrieval apparatus 10 searches a database according to the keyword and the location information. Furthermore, the Web regional information retrieval apparatus 10 transmits the information relevant to the user profile in the information obtained as a search result to the terminal 20 as the information about the region indicated by the location information. Thus, the user can be provided with the information relevant to the attribute of the user in association with the current location of the user.

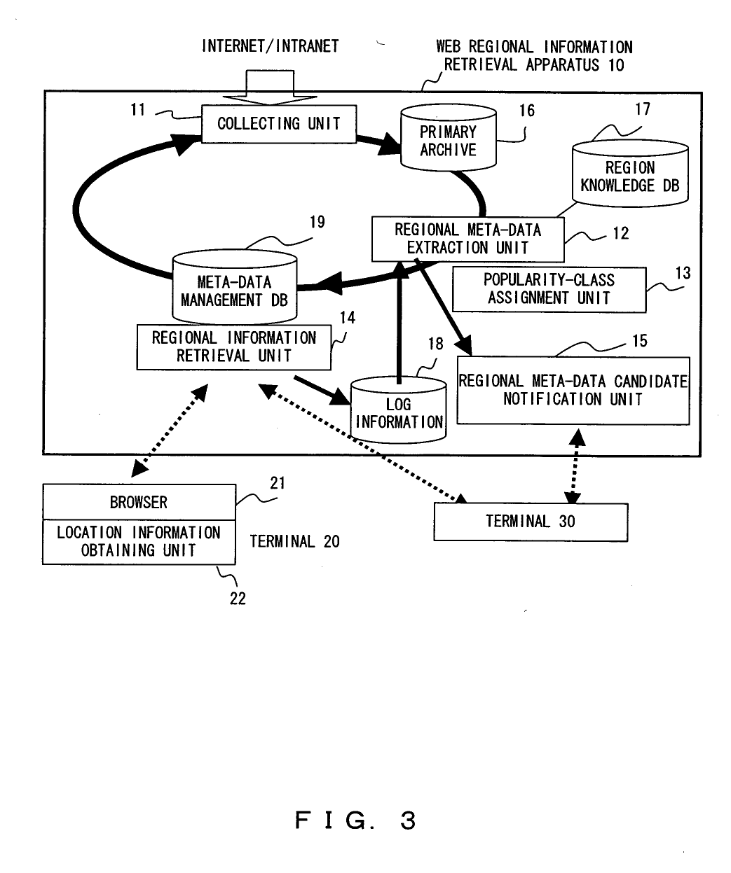

The characteristic portion of the Web regional information retrieval apparatus 10 is enclosed by the rectangle indicated by the dotted lines in FIG. 2. The characteristic portion is mainly explained below by referring to FIG. 3 showing the configuration of the Web regional information retrieval apparatus 10 according to the first embodiment of the present invention.

FIG. 3 is a block diagram showing the function of the Web regional information retrieval apparatus 10. As shown in FIG. 3, the Web regional information retrieval apparatus 10 is connected to the WWW of the Intranet, the Internet, etc., and comprises a collecting unit 11, a regional meta-data extraction unit 12, a popularity-class assignment unit 13, a region information retrieval unit 14, a regional meta-data candidate notification unit 15, a primary archive 16, a region knowledge DB 17, a retrieval log 18, and a meta-data management DB 19.

The collecting unit 11 collects information in the WWW (hereinafter referred to as a Web page) and writes the information for management of the collected Web page to the primary archive 16. The collecting unit 11 is, for example, a WWW crawler for collecting information from the WWW. Since the technology of collecting information from the WWW is well known, the detailed explanation of the collecting method is omitted here. The collecting unit 11 obtains meta-data assigned by its author from the Web page, and writes the obtained meta-data to the meta-data management DB 19.

The regional meta-data extraction unit 12 extracts regional meta-data which is the meta-data about the region relevant to the Web page, associates the data with the collected Web page, and writes the regional meta-data to the meta-data management DB 19.

The popularity-class assignment unit 13 calculates the popularity which is the meta-data about the popularity level of the collected Web page, associates it with the corresponding Web page, and writes the popularity to the meta-data management DB 19. The popularity-class assignment unit 13 extracts the keyword from the contents of the collected Web pages, and writes to the meta-data management DB 19 the keywords associated with the Web page. Thus, the popularity-class assignment unit 13 assigns the popularity and the keyword to the Web page. Since the technology of assigning the popularity to a Web page by the popularity-class assignment unit 13 and the technology of classifying the contents of a Web page are well known, the detailed explanation of the method of calculating the popularity and the method for classification are omitted here.

The region information retrieval unit 14 retrieves the Web page collected from the WWW based on the location information and the keyword received from the terminal 20, and outputs the obtained URI, URL, etc. of the Web page as a result of the retrieval to the terminal 20. The retrieval result and the log of the access of users are written to the retrieval log 18. The information stored in the retrieval log is totalized by Web page with a predetermined timing, and the totalization result is used in extracting regional meta-data.

The regional meta-data candidate notification unit 15 notifies a terminal 30 of the author of a candidate of the regional meta-data to be added to the Web page when the author generates or updates the Web page. A candidate of the regional meta-data is generated by the regional meta-data extraction unit 12 similarly as in the process of extracting regional meta-data.

The primary archive 16 stores the information for management of a collected Web page. The region knowledge DB 17 stores necessary information for extracting regional meta-data from the collected Web pages. The retrieval log 18 is a log storing retrieval results and access of users to the Web pages. The meta-data management DB 19 stores the meta-data relating to the collected Web pages. The meta-data is extracted from or added to the Web pages by the collecting unit 11, the regional meta-data extraction unit 12, and the popularity-class assignment unit 13.

The terminal 20 of a user comprises a browser 21 and a location information obtaining unit 22. The browser 21 is software for browsing a Web page. Since it is a well-known technology, the explanation is omitted here. The location information obtaining unit 22 obtains the location information indicating the current geographical location of a terminal. To obtain the location information, various well-known technologies such as GPS, radio technology, etc. can be used.

For example, when GPS is used to obtain the location information, the latitude and the longitude of the current location of terminal 20 is obtained as location information. When radio technology is used to obtain the location information, the latitude and the longitude of the base station, which is the current communications destination of the terminal, or the room number of the building can be obtained as the location information. Since the GPS and the radio technology are well known, the detailed explanation is omitted here.

Terminal 30 of an author receives a notification of a candidate for regional meta-data to be added to the Web page from the regional meta-data prospect notification unit 15 when the author generates or updates the Web page.

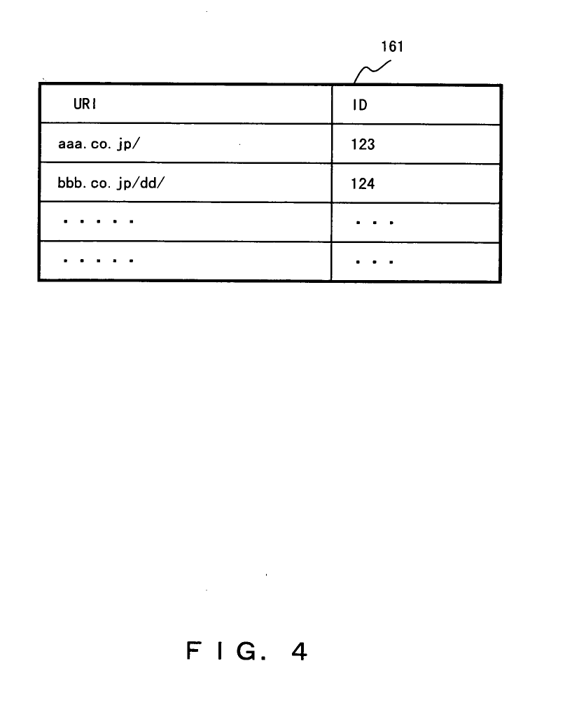

The information stored in the primary archive 16, the region knowledge DB 17, the retrieval log 18, and the meta-data management DB 19 are explained below by referring to FIGS. 4 through 13.

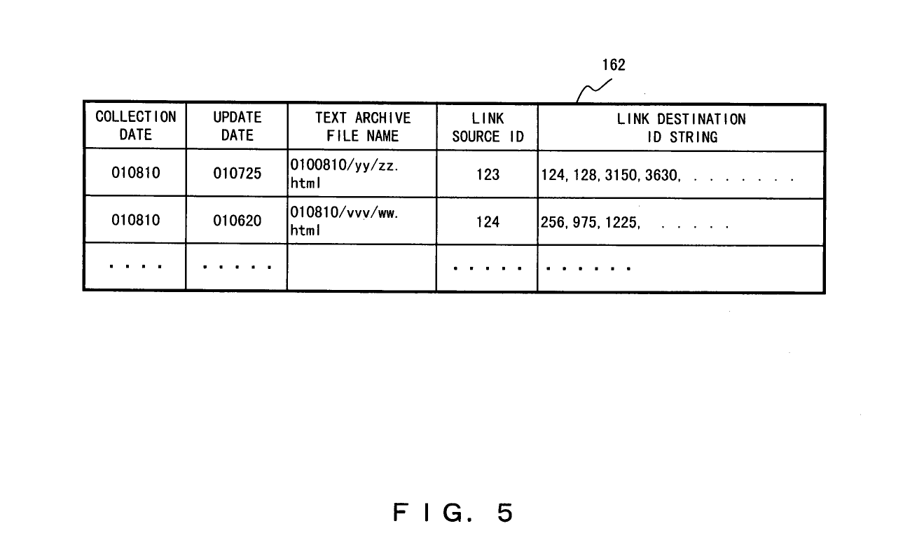

First, the information stored in the primary archive 16 is described below by referring to FIGS. 4 and 5. The primary archive 16 stores a URI (uniform resource indicator)-ID table 161 and a reference table 162 for management of collected Web pages. FIG. 4 shows an example of the data structure of the URI-ID table 161. FIG. 5 shows an example of the data structure of the reference table 162.

As shown in FIG. 4, the URI-ID table 161 stores the flag information indicating the location of a Web page in the WWW, that is, a URI or a URL with the ID assigned to each Web page associated with them. The information is written to the URI-ID table 161 by the collecting unit 11 when a Web page is collected.

The reference table 162 stores the reference data indicating the reference among the collected Web pages. As shown in FIG. 5, the reference data includes, as items, the collection date of a Web page, the date of update, the text archive file name of a Web page, the ID (linking ID) of a Web page including the text archive file, and the ID (linked ID) of another Web page which is a link destination of the Web page.

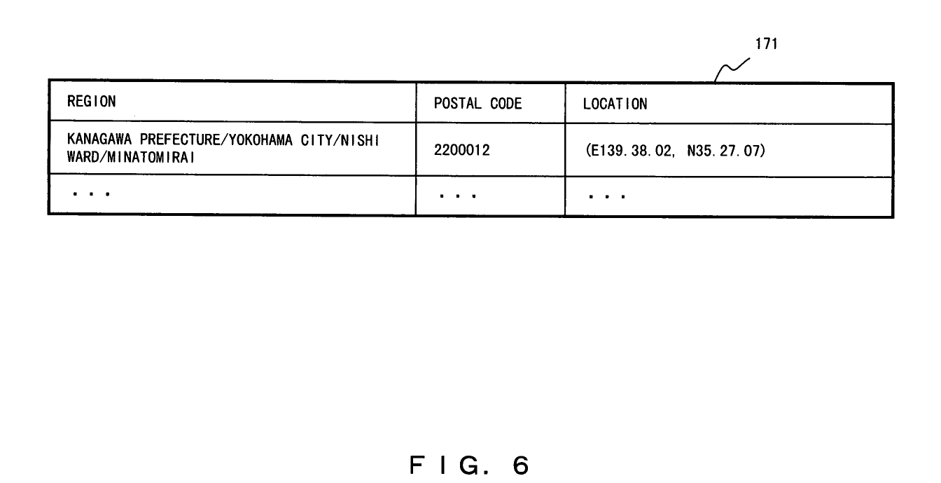

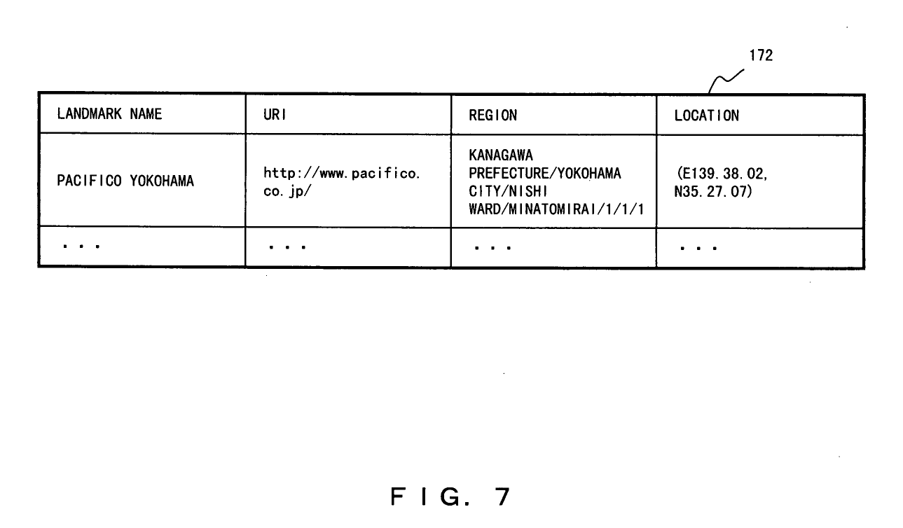

The information stored in the region knowledge DB 17 is explained below by referring to FIGS. 6 and 7. The region knowledge DB 17 stores a region segmentation table 171 and a landmark knowledge table 172. As shown in FIG. 6, the region segmentation table 171 stores the name of the region (that is, the place-name), the postal code of the region, and the latitude and the longitude of the region.

The landmark knowledge table 172 stores landmark data about landmarks. A landmark refers to a famous building, etc. which can be a mark of a region. As shown in FIG. 7, landmark data includes, as items, the name of a landmark, the domain of a Web page which provides information about the landmark, the name of the region in which the landmark exists, the latitude and the longitude of the location of the landmark.

The region knowledge DB 17 stores information in advance, and can be updated at any time, for example, when a place-name, a block segmentation, etc. are changed.

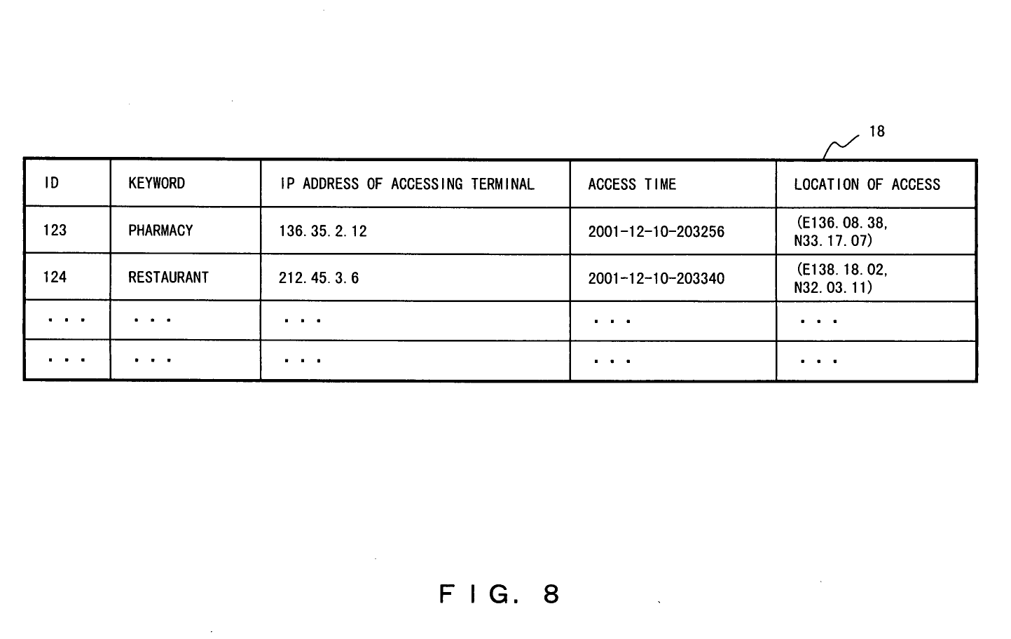

Then, the information stored in the retrieval log 18 is explained by referring to FIG. 8. The retrieval log stores retrieval result data. The retrieval result data indicates when, where, and with which keyword a Web page was retrieved and accessed. As shown in FIG. 8, the retrieval result data includes, as items, the ID of a retrieved Web page, the keyword used in retrieval, the IP address of an accessing user, the access date and time, and the latitude and longitude of an access location. The keyword, the IP address of an accessing user, and the access location are obtained when the Web regional information retrieval apparatus 10 receives a retrieval request from the terminal 20.

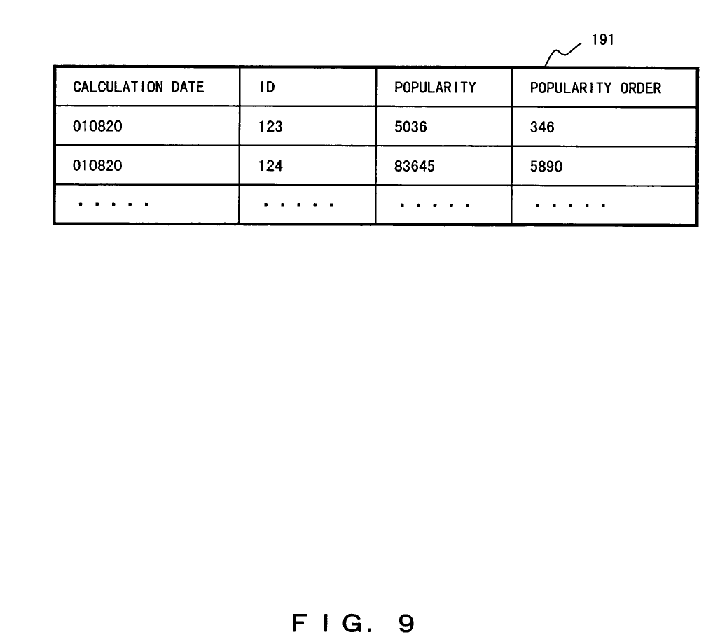

The information stored in the meta-data management DB 19 is explained below by referring to FIGS. 9 through 13. The meta-data management DB 19 stores a popularity table 191, a URI meta-data table 192, a regional meta-data table 193, an author-assigned meta-data table 194, and a retrieval log total table 195. The information stored in each table is described below.

The popularity table 191 stores popularity data for each Web page. As shown in FIG. 9, the popularity data includes, as items, the calculation date of popularity, the ID of a Web page, the popularity calculated on the Web page and the popularity order based on the popularity. The popularity and the order of the popularity are calculated by the popularity-class assignment unit 13, and written to the popularity table 191.

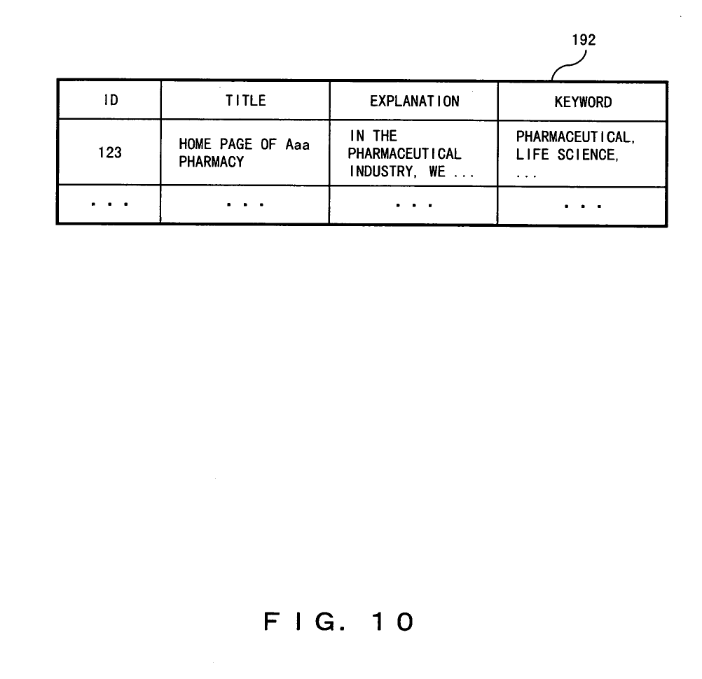

As shown in FIG. 10, in the meta-data added to each Web page, the URI meta-data table 192 stores the title of the Web page, the explanation, and the keyword together with the ID of the Web page. The title and the explanation is retrieved from a Web page by the collecting unit 11, and written to the URI meta-data table 192. The keyword is added to the Web page by the popularity-class assignment unit 13 based on the contents, etc. of the text of the Web page, and written to the URI meta-data table 192.

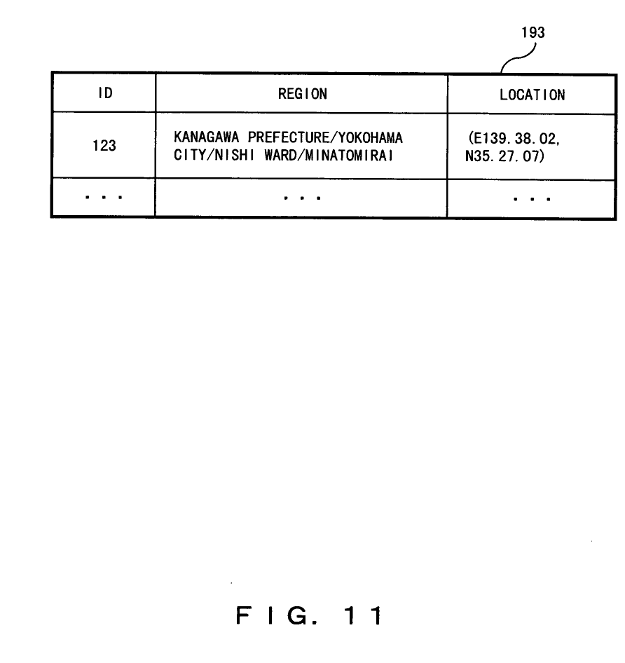

As shown in FIG. 11, the regional meta-data table 193 stores the regional meta-data about a Web page together with the ID of the Web page. The regional meta-data is extracted by the regional meta-data extraction unit 12 from the text archive, etc. of a Web page, and written to the regional meta-data table 193. In FIG. 11, the name of the region related to a Web page, and the latitude and longitude indicating the geographical location of a location related to the Web page are shown as regional meta-data.

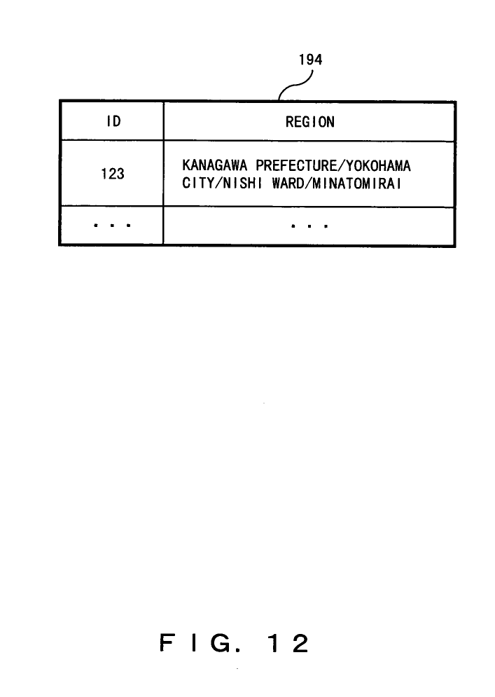

As shown in FIG. 12, in the meta-data added to a Web page by the author, the author-assigned meta-data table 194 stores regional meta-data of the Web page. The regional meta-data is retrieved from the Web page, and written to the author-assigned meta-data table 194.

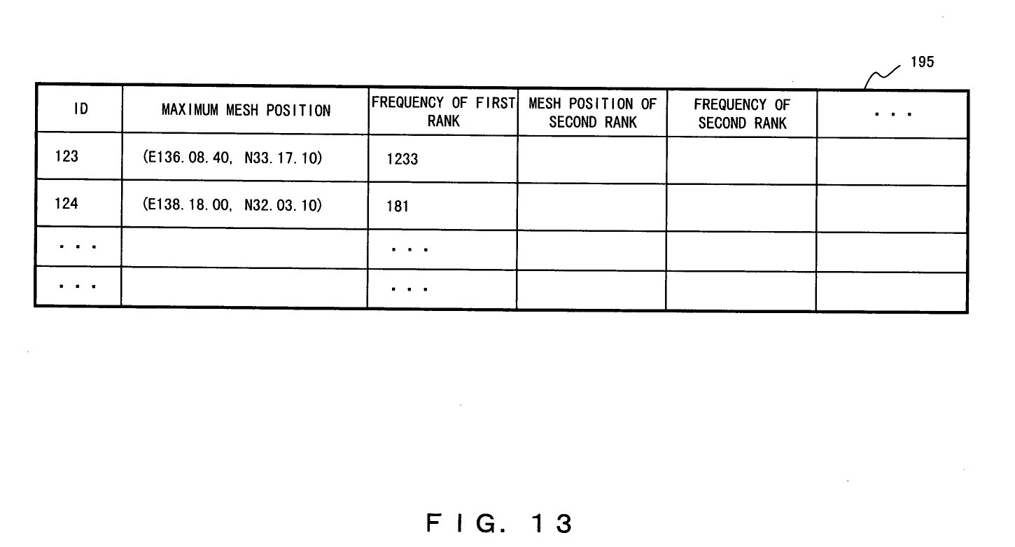

The retrieval log total table 195 stores log total data obtained by totalizing the retrieval log 18 by Web page. The log total data indicates the frequency of the access to the Web page. As shown in FIG. 13, the log total data includes, as data, the ID of a Web page, the access location (also referred to as a mesh location) of higher N access in frequency, and the access frequency from each access location. With the error in location information taken into account, the first second of the latitude and the longitude indicating the access location is rounded. Since one second roughly corresponds to 25 m, the access location is divided into 250 m mesh sections.

The process performed by the Web regional information retrieval apparatus 10 is explained below. First, the procedure of the process performed by the collecting unit 11 is briefly explained.

The collecting unit 11 collects a Web page from the WWW, and assigns identification information (hereinafter referred to as an ID) for identification of the Web page. Then, the URI indicating the location of the Web page in the WWW, and the ID corresponding to the Web page are written to the URI-ID table 161. Furthermore, the collecting unit 11 extracts the reference between Web pages, and writes the extracted reference to the reference table 162.

The collecting unit 11 obtains meta-data from the collected Web pages. Meta-data can be, for example, the title of the Web page, the explanation of the Web page, the information about the region relating to the Web page, that is, regional meta-data, etc. In the obtained meta-data, the title and the explanation of a Web page are written to the URI meta-data table 192 shown in FIG. 10 together with the ID of the Web page. In the obtained meta-data, the regional meta-data is written to the author-assigned meta-data table 194 shown in FIG. 12 together with the ID of the Web page.

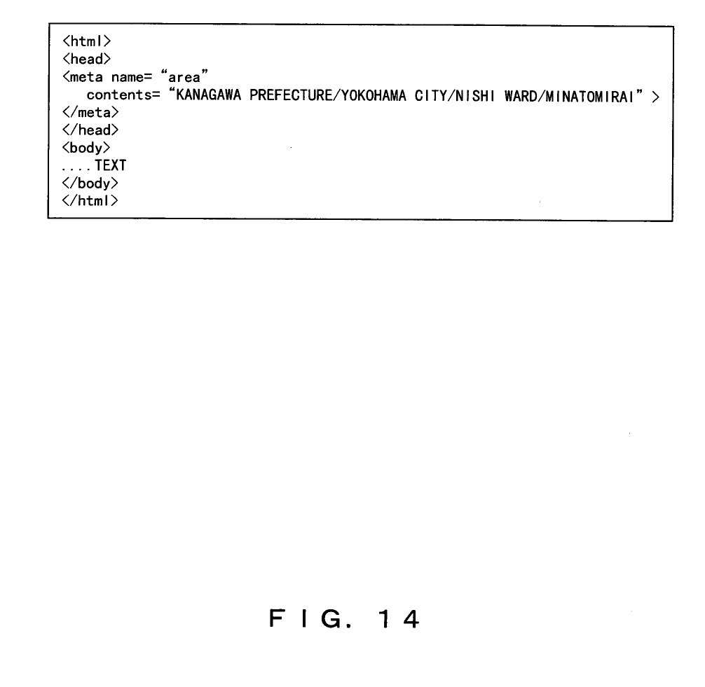

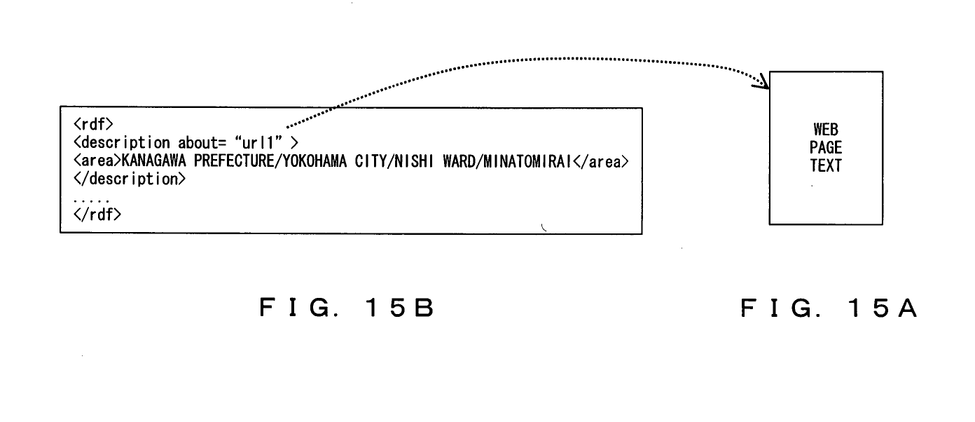

The process of obtaining meta-data added to the Web page by the author is explained in more detail by referring to FIGS. 14, 15A and 15B.

The meta-data can be added in a Web page as shown in FIG. 14, or can be stored in the meta-data file related to the Web page as shown in FIGS. 15A and 15B.

First, the case in which regional meta-data is added into a Web page is explained below by referring to FIG. 14. FIG. 14 shows an example of the source of the Web page described in the HTML (hyper text markup language). In FIG. 14, the meta-data is added into the Web page using a META tag in the portion enclosed by HEAD tags. In the example shown in FIG. 14, the data name of the meta-data added to the Web page is “area”, and the contents of the meta-data are “Kanagawa Prefecture/Yokohama City/Nishi Ward/Minatomirai”.

Then, the case in which meta-data is stored in the meta-data file associated with the Web page is explained below by referring to FIGS. 15A and 15B. FIGS. 15A and 15B show the case in which the RDF (resource description framework) statement shown in FIG. 15A is provided for the Web page (resource) shown in FIG. 15B.

The RDF description shown in FIG. 15A corresponds to the meta-data file. The RDF description shown in FIG. 15A assigns the regional meta-data having the contents of “Kanagawa Prefecture/Yokohama City/Nishi Ward/Minatomirai” to the Web page (shown in FIG. 15B) whose URL (uniform resource locator) is “url1”.

The collecting unit 11 extracts the meta-data assigned to the Web page as shown in FIGS. 14, 15A and 15B, associates the extracted meta-data with the ID of the Web page, and writes the resultant data to the URI meta-data table 192 and/or an author meta-data table 163.

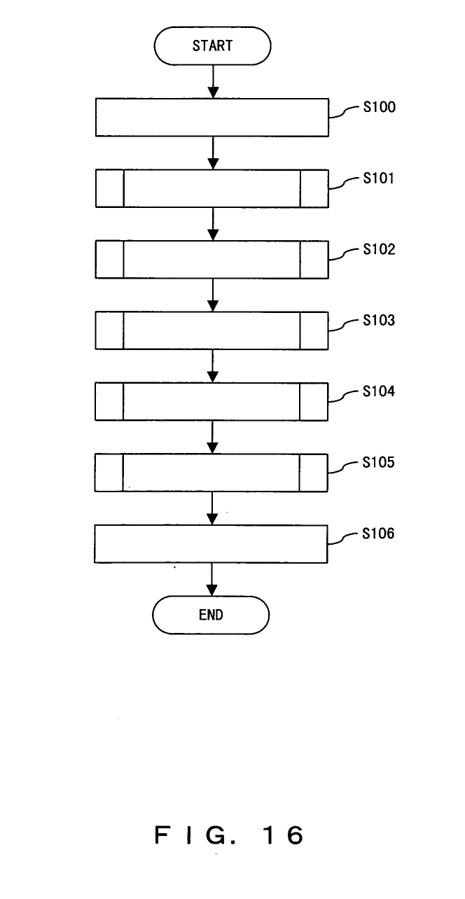

When the Web page is collected from the WWW by the collecting unit 11, the regional meta-data extraction unit 12 extracts the regional meta-data which is the meta-data about the region to which the Web page relates from the Web page, etc. The procedure of the process performed by the regional meta-data extraction unit 12 is explained below by referring to FIGS. 16 through 21.

FIG. 16 shows the entire flow (main flow) of the process of extracting regional meta-data.

As shown in FIG. 16, first in FIG. 100, the regional meta-data extraction unit 12 obtains the ID of the Web page from the URI-ID table 161. Then, in S101, the regional meta-data extraction unit 12 extracts regional meta-data from the information in the text of the Web page specified by the ID.

In S102, the regional meta-data extraction unit 12 extracts the regional meta-data from the meta-data assigned to the Web page by the author in advance. Then, in S103, the regional meta-data extraction unit 12 extracts the regional meta-data from the author-assigned meta-data table 194. After S103, in S104, the regional meta-data extraction unit 12 extracts from the regional meta-data of a Web page which is the link source of the current Web page the regional meta-data of the Web page. In S105, the regional meta-data extraction unit 12 extracts the regional meta-data from the character string indicating the URI.

The process of extracting the regional meta-data in S101 through S105 is sequentially performed from S101. However, when N pieces of regional meta-data are extracted before S105, control is passed to step S106 without performing subsequent processes. That is, there is a priority order set in the process of extracting the regional meta-data from S101 to S105.

Finally, in S106, the regional meta-data extraction unit 12 associates the extracted N pieces of regional meta-data with the ID of the Web page, and writes the resultant data to the regional meta-data table 193, thereby terminating the process.

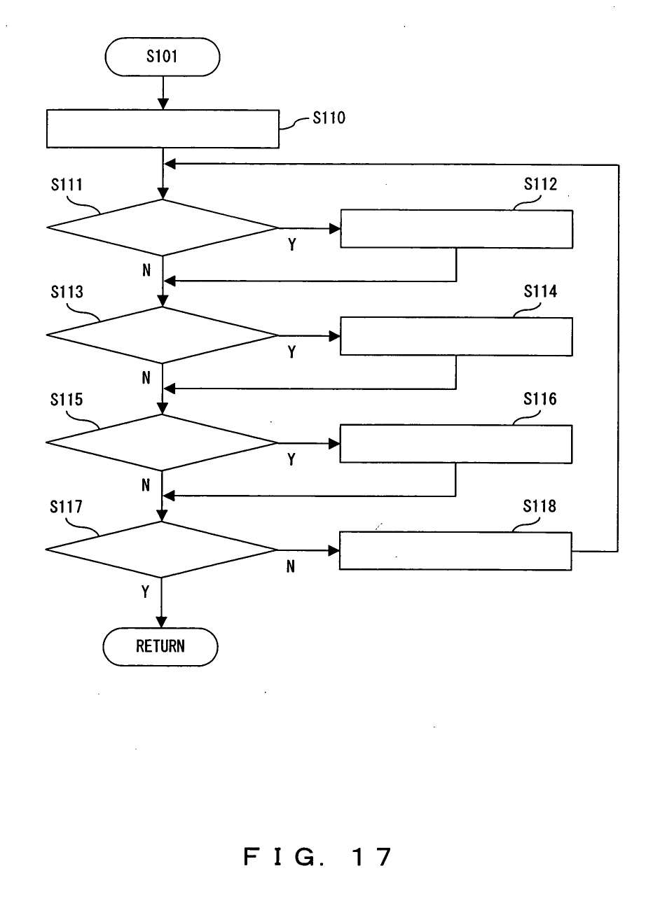

Described below is the detailed procedure of each process from S101 to S105. First, the process in S101 in which the regional meta-data is extracted from the text of the Web page is explained by referring to FIG. 17.

First, in s110, the regional meta-data extraction unit 12 refers to the reference table 162, and obtains the text archive file name of the Web page from the reference data containing the ID obtained in S100 shown in FIG. 16 as the link source ID. When there are two or more pieces of reference data having the same link source, the text archive file name is obtained from the reference data having the latest collection date.

Then, in S111, the regional meta-data extraction unit 12 retrieves the text file from the WWW based on the text archive file name, and determines whether or not the text contains a postal code. If it is determined in S111 that the text contains a postal code (YES in S111), then control is passed to step S112. If it is determined in the determination in S111 that the text does not contain a postal code (NO in S111), control is passed to step S113.

In S112, the regional meta-data extraction unit 12 refers to the region segmentation table 171, and obtains the name of the region (that is, the place-name) corresponding to the postal code contained in the text, and the latitude and the longitude of the region as the regional meta-data of the Web page.

In S113, the regional meta-data extraction unit 12 determines whether or not the expression of an address, that is, the address expression, is contained in the text based on the place name stored in the table not shown in the attached drawings. If the text contains the address expression (YES in S113), control is passed to step S114. If the text does not contain the address expression (NO in S113), control is passed to step S115.

In S114, the regional meta-data extraction unit 12 extracts the address expression as the regional meta-data of the Web page. At this time, the regional meta-data extraction unit 12 extracts the address expression which designates the region in a narrower range.

The address expression generally has a hierarchical structure. When a hierarchical structure is prepared, the regional meta-data extraction unit 12 extracts an address expression which designates the deepest hierarchical level, that is, in the narrowest range or the region.

For example, when the address expression “In the shop in Minatomirai, Nishi Ward, Yokohama City in Kanagawa Prefecture . . . ” is contained in the text, the address expression corresponds to the “Kanagawa/Yokohama”, “Kanagawa/Yokohama/Nishi Ward”, and “Kanagawa/Yokohama/Nishi Ward/Minatomirai”. In this case, the regional meta-data extraction unit 12 extracts the “Kanagawa/Yokohama/Nishi Ward/Minatomirai” as the regional meta-data of the Web page.

In S115, the regional meta-data extraction unit 12 determines whether or not the name of a landmark stored in the landmark knowledge table 172 is contained in the above-mentioned text. The landmark refers to a proper noun relating to the region such as famous buildings, spa, historical area, etc. For example, a landmark can be “Imperial Hotel” as a famous building, “Gora” as a famous spa, “Kai” as a famous historical area, etc. If the text does not contain the name of a landmark, control is returned to the main flow shown in FIG. 16. If the text contains the name of a landmark, control is passed to step S116.

In S116, the regional meta-data extraction unit 12 refers to the landmark knowledge table 172, and obtains the name of the region corresponding to the name of the landmark contained in the text and the latitude and the longitude indicating the location of the region as the regional meta-data of the Web page.

Then, in S117, the regional meta-data extraction unit 12 determines whether or not the processes from S111 to S116 have been performed on the Web page in the same site which is the link destination n levels ahead of the Web page having the ID obtained in S100 shown in FIG. 16. If the determination result is NO in step S117, control is passed to step S118. If the determination result is YES in step S117, then control is returned to the main flow shown in FIG. 16. The linked levels can be, for example, about two levels.

In S118, the regional meta-data extraction unit 12 becomes the link destination in the same site as the processed Web page, and obtains the text archive file name of the ID of the Web page from the reference table 162, thereby returning control to S111.

For example, although the text of a Web page which is the top page of a site does not contain a postal code, an address expression, etc., there can be the case in which the text of the Web page linked to by a link character string such as “access information”, etc. from the Web page contains an address expression, etc. Therefore, the regional meta-data extraction unit 12 extracts regional meta-data not only from the text of a Web page, but also from the text of a linked Web page from the Web page.

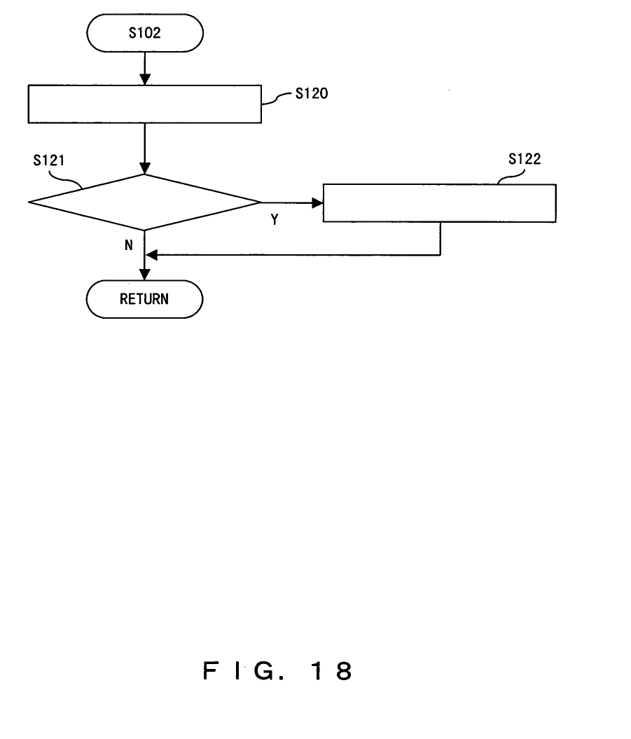

Then, the process in S102 of extracting regional meta-data from the meta-data added by the author to a Web page is explained below by referring to FIG. 18.

First, in S120, the regional meta-data extraction unit 12 searches the author-assigned meta-data table 194 using the ID obtained in S100 shown in FIG. 16. Then, in S121, the regional meta-data extraction unit 12 determines whether or not the meta-data corresponding to the ID is stored in the author-assigned meta-data table 194. When the corresponding meta-data is stored in the author-assigned meta-data table 194, (YES in S121), then control is passed to S122. Otherwise (NO in S121) control is returned to the main flow shown in FIG. 16.

In S122, the regional meta-data extraction unit 12 obtains the meta-data as regional meta-data, and control is returned to the main flow shown in FIG. 16.

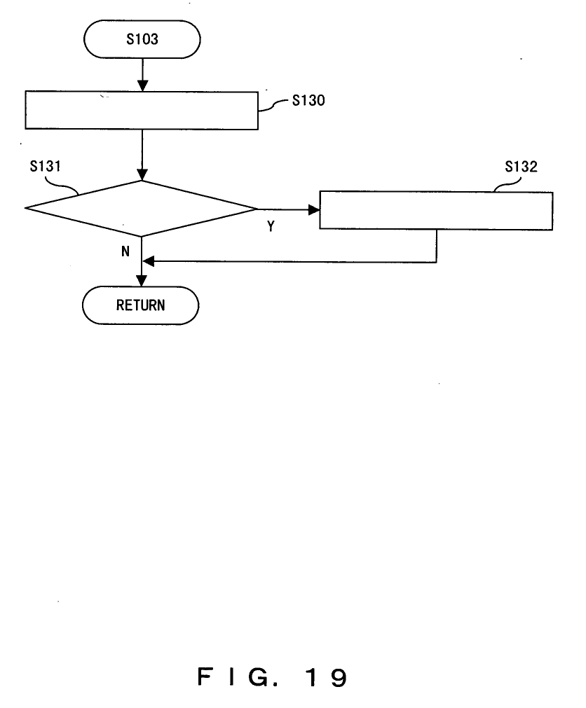

The process in S103 of extracting the regional meta-data from the author-assigned meta-data table 194 is explained by referring to FIG. 19.

In S130, the regional meta-data extraction unit 12 searches the retrieval log total table 195 using the ID obtained in S100 shown in FIG. 16. In S131, the regional meta-data extraction unit 12 determines whether or not the log total data corresponding to the ID has been stored in the retrieval log total table 195. If the corresponding log total data is stored in the retrieval log total table 195 (YES in S131), control is passed to S132. Otherwise (NO in S131), control is returned to the main flow shown in FIG. 16.

In S132, the regional meta-data extraction unit 12 obtains the most frequent access location as regional meta-data from the log total data, and control is returned to the main flow shown in FIG. 16.

For example, if the number of users who selected and accessed a Web page from the Web pages obtained as a retrieval result is 1000 in which 300 users accessed from a specific location (mesh), then the location is considered to relate to the corresponding Web page. Therefore, the regional meta-data extraction unit 12 extracts the information indicating such location as regional meta-data.

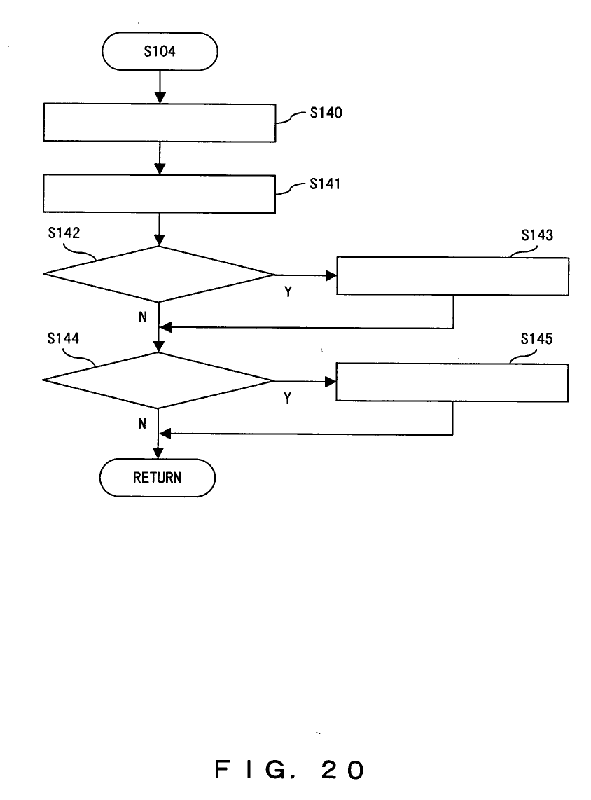

Next, the process in S104 of extracting regional meta-data from another Web page which is another Web page which if a link source of a Web page is explained by referring to FIG. 20.

First, in S140, the regional meta-data extraction unit 12 searches the reference table 162 in the reverse order, and obtains the IDs of one or more Web pages having the obtained IDs in S100 shown in FIG. 16 as linked IDs. Thus, the Web pages which are link sources of the Web pages having the IDs obtained in S100, that is, the IDs of the linking pages are obtained.

In S141, the regional meta-data extraction unit 12 uses one or more IDs obtained in S140 as retrieval keys, and obtains one or more pieces of regional meta-data about the linking page from the regional meta-data table 193. As described above, the regional meta-data can be the name of a region, and can be the latitude and longitude indicating the location of the geographical location of a region.

In S142, the regional meta-data extraction unit 12 determines whether or not the name of the region which is regional meta-data common in the linking pages larger than a predetermined number is contained in the regional meta-data obtained in S141. If there is the name of the region which is the regional meta-data common in the linking pages (YES in S142), then control is passed to S143. Otherwise (NO in S142), control is passed to S144.

In S143, the regional meta-data extraction unit 12 obtains the name of the region as regional meta-data, and control is passed to S144.

In S144, the regional meta-data extraction unit 12 determines whether or not the regional meta-data obtained in S141 contains the latitude and longitude which is the regional meta-data common among the linking page larger in number of a predetermined number. If there are the corresponding latitude and longitude (YES in S144), then control is passed to S145. Otherwise (NO in S144), control is returned to the main floor shown in S16.

In S145, the regional meta-data extraction unit 12 obtains the latitude and the longitude as regional meta-data, then control is returned to the main flow shown in FIG. 16.

For example, relating to the Web page P1, although the regional meta-data has not been extracted in the process of S101 through S103 shown in FIG. 16, and when there are 100 pages of linking pages of the Web page P1, and if 60 pages of the linking pages have the name of the region “Kanagawa/Yokohama/Nishi Ward/Minatomirai”, then it is assumed that the Web page P1 also relates to the region “Kanagawa/Yokohama/Nishi Ward/Minatomirai”. This also holds when the regional meta-data refers to a latitude and a longitude. Therefore, the regional meta-data extraction unit 12 obtains the regional meta-data common among the linking pages as the regional meta-data of the Web page P1.

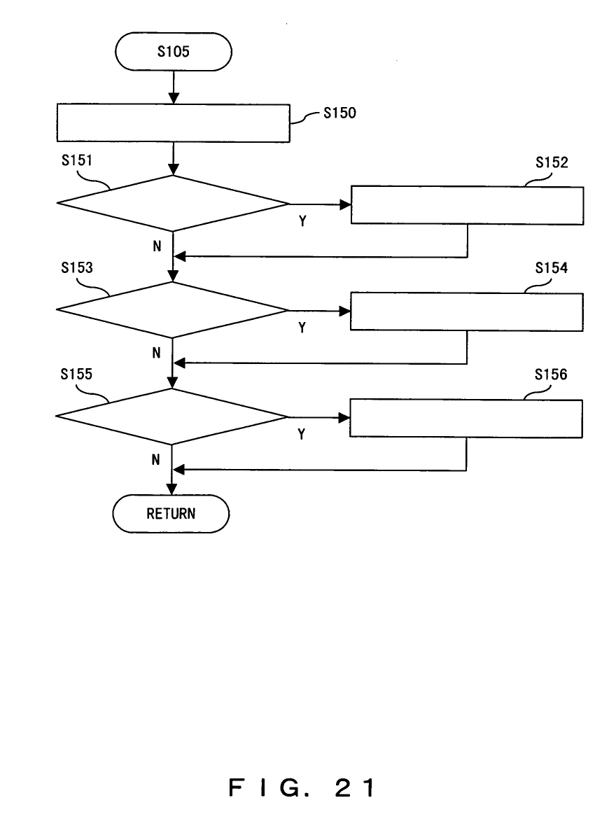

Next, by referring to FIG. 21, the process of extracting regional meta-data from a character string indicating the URI in S105 is explained below. First, in S150, the regionl meta-data extraction unit 12 obtains the URI corresponding to the ID obtained in S100 shown in FIG. 16 from the URI-ID table 161.

In S151, the regional meta-data extraction unit 12 determines whether or not the obtained URI is a regional domain.

If the URI is a regional domain (YES in S151) control is passed to S152. Otherwise, control is passed to S153.

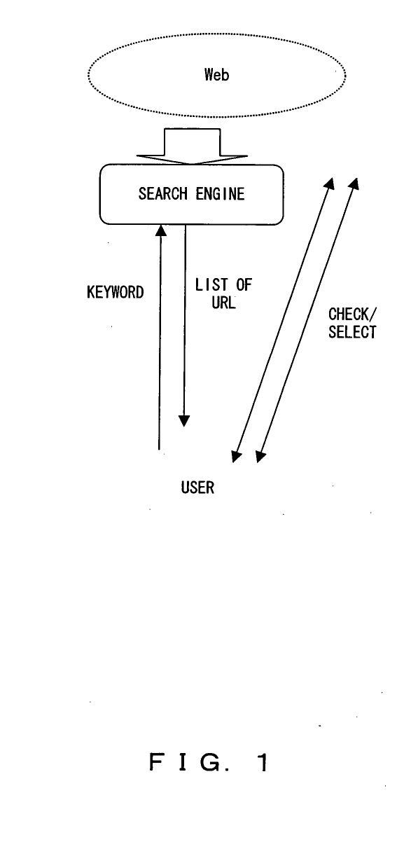

In S152, the regional meta-data extraction unit 12 extracts from the regional domain the regional meta-data about the Web page corresponding to the ID obtained in the S100 shown in FIG. 1.

The regional domain refers to a domain having the domain name containing the name of the city, town, and village, the name of the capital, prefecture, etc. There is the standard of a regional domain. For example, in Japan, “xxxx. ward name. governmental city name.” or “xxx. city, ward, village, and town name. capital and prefecture name. jp”, etc. are set as standards. To be more practical, the domain “tokyo.jp” refers to the regional domain of “Tokyo, the capital”. The Web page having a regional domain is considered to relate to the region. Therefore, the regional meta-data extraction unit 12 can extract the regional meta-data about the Web page from the reference data.

In S153, the regional meta-data extraction unit 12 determines whether or not the landmark knowledge table 172 stores a landmark data having a domain matching the domain in the URI obtained in S150. If the corresponding landmark data is stored (YES in S153), then control is passed to S154. Otherwise (NO in S153), control is passed to the S155.

In S154, the regional meta-data extraction unit 12 obtains the name of the region and the latitude and longitude from the landmark data having the same domain as the URI as the regional meta-data about the Web page corresponding to the ID obtained in S10 shown in FIG. 16, and control is passed to S155 because it can be assumed that the Web page can be regarded as relating to the region in which the landmark having the same domain exists.

In S155, the regional meta-data extraction unit 12 determines whether or not the URI obtained in S150 contains the character string relating to the name of the region. The name of the region is stored in the table not shown in the attached drawings. When there is a character string relating to the name of the region in the URI (YES in S155), then control is passed to S156. Otherwise (NO in S155), control is returned to the main flow shown in FIG. 16.

In S156, the regional meta-data extraction unit 12 obtains the name of the region relating to the character string contained in the URI as the regional meta-data about the Web page corresponding to the ID obtained in S100 shown in FIG. 16, and control is returned to the main flow shown in FIG. 16.

For example, the character strings “kanagawa”, “tokyo”, “new york”, “boston”, etc. contained in the URI are considered to relate respectively to Kanagawa, Tokyo, New York, and Boston in the respective Web pages corresponding to the URIs.

As described above, the regional meta-data extraction unit 12 extracts the regional meta-data. The processes in S101 through S105 are performed using a computer, etc. by analyzing a computer, a link relation, etc. without an operator. Therefore, it is not necessary to manually prepare a database to present a mobile terminal with the information relating to the current location. Furthermore, as explained above in S101 through S105, the regional meta-data to be added to Web pages is extracted using a number of methods, thereby realizing the complement of the restrictions on the extraction precision by automatically extracting regional meta-data.

Before, after, or in parallel to the process of the regional meta-data extraction unit 12 extracting the regional meta-data about the Web page, the popularity-class assignment unit 13 calculates the popularity, that is, the meta-data indicating the level of the popularity of a Web page, and writes the calculated popularity and the popularity order based on the popularity to the popularity table 191 with the calculation date and the ID of the Web page. Furthermore, the popularity-class assignment unit 13 generates a keyword of the Web page based on the text, etc. of the Web page, and writes the keyword to the URI meta-data table 192.

As described above, since the process of calculating the popularity and the process of generating a keyword are well known, the explanation of these processes is omitted here.

The meta-data about the Web pages collected as described above are obtained. Upon receipt of a retrieval request from the terminal 20, the region information retrieval unit 14 retrieves a Web page from the WWW using the meta-data obtained as described above. The retrieval by the region information retrieval unit 14 is performed as follows.

(1) First, the region information retrieval unit 14 obtains the retrieval request such as a keyword and a category, and location information from the terminal 20 of a user.

(2) Then, the region information retrieval unit 14 obtains the regional meta-data table 193 which is the regional meta-data about a Web page satisfying the corresponding retrieval request, and obtains the higher order M cases of Web pages on the region in the following priority. Hereinafter, the priority about a region is referred to as a regional priority.

(2-1) The Web page having the regional meta-data indicating the region located close to the geographical location indicated by the location information received from the terminal 20, for example, within 1 km south or north.

(2-2) The Web page having the regional meta-data indicating the regional section close to the location indicated by the location information received from the terminal 20.

(2-3) The Web page having the regional meta-data indicating a higher regional section in the regional section containing the location indicated by the location information received from the terminal 20.

(2-4) The Web page having the regional meta-data indicating the regional section similar to the regional section containing the location indicated by the location information received from the terminal 20. The similar regional section refers to, for example, the regional section having the same two high levels of the regional sections.

The method of determining the regional priority of the Web page is described later in detail.

(3) Furthermore, the region information retrieval unit 14 sorts the retrieval results based on the regional priority determined in (2) above, the popularity, or the matching level with the retrieval request, or the combination of them, and transmits the sorted retrieval results to the terminal 20.

The matching level with the retrieval request is determined based on the number of keywords, etc. contained in the text of the Web page. Since the method of calculating a matching level with the retrieval request is well known, the detailed explanation of the method is omitted here.

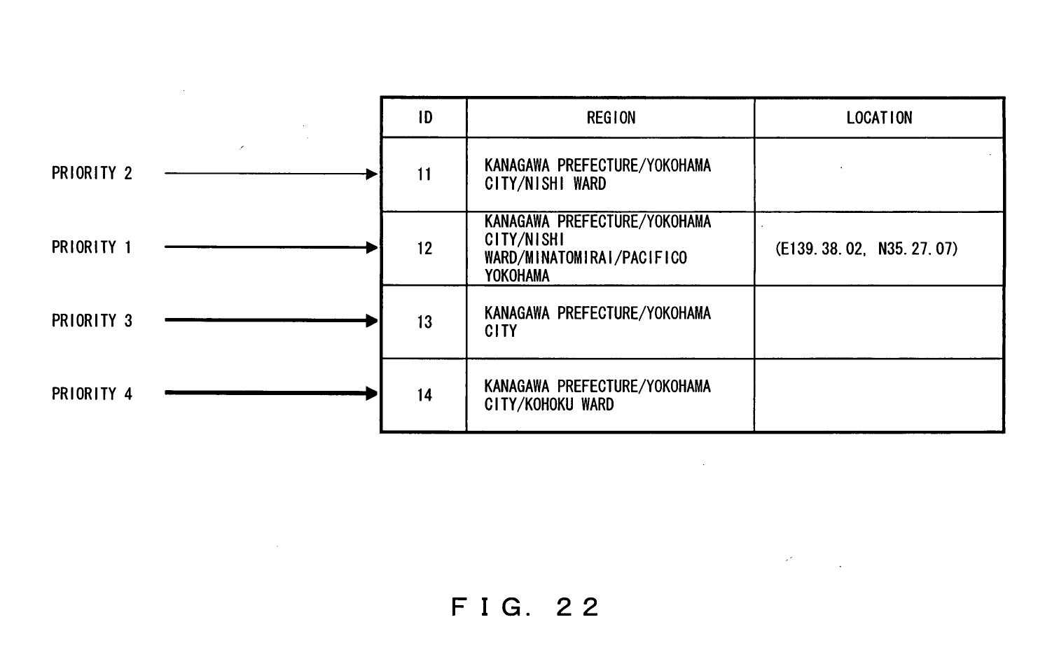

The method of determining the priority relating to the region of a Web page by the region information retrieval unit 14 is explained in detail below. For explanation, it is assumed that the region information retrieval unit 14 has received a retrieval request “to be informed of a restaurant in the vicinity” together with the location information “east longitude 139.37.01, north latitude 35.27.00” from the terminal 20. It is also assumed, as a result of the region information retrieval unit 14 retrieving the regional meta-data about the Web page corresponding to the retrieval request “restaurant”, the regional meta-data as shown in FIG. 22 is obtained. The region information retrieval unit 14 determines the regional priority of these Web pages such that the condition “vicinity” in the retrieval request “to be informed of a restaurant in the vicinity” can be satisfied.

As shown in FIG. 22, the location information that is received from the terminal 20 is . . . The regional section containing the location indicated by the location information is “Kanagawa Prefecture/Yokohama City/Nishi Ward/Minatomirai”.

First, the regional meta-data indicating the location geographically close to the location indicated by this location information is the regional meta-data “east longitude 139.38.02, north latitude 35.27.07” of the Web page having the ID of 12. Therefore, the region information retrieval unit 14 defines the regional priority of the Web page having the ID of 12 as 1.

Then, the region information retrieval unit 14 retrieves the regional meta-data indicating the regional section near the location indicated by the location information from the table shown in FIG. 22. However, the table shown in FIG. 22 does not contain the corresponding regional meta-data.

Furthermore, the region information retrieval unit 14 retrieves the regional meta-data indicating the regional section higher than the regional section “Kanagawa Prefecture/Yokohama City/Nishi Ward/Minatomirai” containing the location indicated by the above-mentioned location information from the table shown in FIG. 22. As a result, the Web page having the ID of 11 and having the regional meta-data indicating the “Kanagawa Prefecture/Yokohama City/Nishi Ward”, and the Web page having the ID of 13 and having the regional meta-data indicating “Kanagawa Prefecture/Yokohama City” are obtained. In the regional section indicated by the meta-data, the regional section immediately above the “Kanagawa Prefecture/Yokohama City/Nishi Ward/Minatomirai” is “Kanagawa Prefecture/Yokohama City/Nishi Ward”, and a further higher regional section is “Kanagawa Prefecture/Yokohama City”. Therefore, the region information retrieval unit 14 defines the regional priority of the Web page having the ID of 11 as 2, and defines the regional priority of the Web page having the ID of 13 as 3.

Then, the region information retrieval unit 14 retrieves the regional meta-data indicating the regional section similar to the regional section “Kanagawa Prefecture/Yokohama City/Nishi Ward/Minatomirai” containing the location indicated by the location information from the table shown in FIG. 22. As a result, the a Web page having the regional meta-data indicating the “Kanagawa Prefecture/Yokohama City/Kohoku Ward” and having the ID of 14 is obtained. Therefore, the region information retrieval unit 14 defines the regional priority of the Web page having the ID of 14 as 4.

In the explanation above, the terminal 20 transmits the retrieval request and the location information to the Web regional information retrieval apparatus 10, and the region information retrieval unit 14 retrieves information from the WWW according to the above-mentioned information. However, when a user transmits a location or a region to the region information retrieval unit 14 in advance, and the region information retrieval unit 14 can retrieve the information relating to the region from the WWW and transmits the retrieval result to the terminal 20 when the terminal 20 reaches a predetermined location or a region.

Thus, the Web regional information retrieval apparatus 10 extracts the regional meta-data indicating the area relating to the manifold Web pages in the WWW and stores the results as associated with the regional meta-data Web page. When the location information indicating the geographical location is received with the retrieval request, a Web page which satisfies the retrieval request, and has regional meta-data indicating the region relating to the location is to be retrieved. Thus, the Web regional information retrieval apparatus 10 retrieves manifold Web pages in the WWW, and the information relating to the location or the place can be obtained. Therefore, the problems of the conventional technology, that is, the problem that the same retrieval results are obtained as a result of a terminal transmitting a retrieval request from any location, and the problem that a database has to be manually generated by a person, can be solved.

Furthermore, the Web regional information retrieval apparatus 10 has the function of allowing the author of a Web page to promote the assignment of meta-data to a Web page. The function is realized in the following two methods.

The first method is realized by the region information retrieval unit 14 providing a retrieval log relating to a Web page which has not been realized in the conventional technology for the author of the Web page in return to the supply of meta-data to the Web page.

As described above, the meta-data management DB 19 stores the retrieval log total table 195. The table 195 stores the total log data indicating who and how often the Web pages have been accessed. The region information retrieval unit 14 transmits the total log data about the Web page of the author to the terminal 30 of the author. The author can use the total log data relating to the Web page generated by the author as the guideline of the author site. For example, the author can customize the contents of a Web page for a specific region based on the high frequency of access from the region of the Web page generated by the author.

The second method is realized by the regional meta-data candidate notification unit 15 notifying the author of a Web page of the candidate for the meta-data to be added to the Web page.

As described above, the regional meta-data extraction unit 12 extracts regional meta-data from the text, etc. of a Web page. The regional meta-data candidate notification unit 15 notifies the author of the regional meta-data extracted by the regional meta-data extraction unit 12 as a candidate of meta-data to be added to a Web page.

For example, when an author registers a Web page newly generated by the author in a server, the regional meta-data extraction unit 12 extracts a candidate for regional meta-data to be added to the Web page from the information about the text of the Web page and the character string indicating the URI of the Web page. The method of extracting a candidate for regional meta-data from the text of a Web page and the character string indicating the URI is similar to the method of extracting the regional meta-data explained by referring to FIGS. 17 and 21.

The regional meta-data candidate notification unit 15 transmits the extracted regional meta-data to the terminal 30 or the author as a candidate for regional meta-data to be added to the Web page. The author selects data to be used as regional meta-data from among the received candidates for regional meta-data, and assigns the regional meta-data to the Web page.

Furthermore, for example, when the author registers a Web page updated by the author in the server, the regional meta-data extraction unit 12 can also extract a candidate for regional meta-data to be added to a Web page from the author-assigned meta-data table 194 and the regional meta-data of the linking page of the current Web page in addition to the information in the text of the Web page and the character string indicating the URI of the Web page. The methods of extracting a prospect for regional meta-data from the author-assigned meta-data table 194 and the regional meta-data of the linking page are similar to the method for extracting regional meta-data explained above by referring to FIGS. 19 and 20.

Then, as in generating a Web page, the regional meta-data candidate notification unit 15 transmits the extracted regional meta-data as a candidate to the terminal 30 of the author. The author selects data for use as regional meta-data from the received candidates, and assigns the regional meta-data to the Web page.

Thus, by notifying the author of the candidate for regional meta-data, the author can more easily add the regional meta-data to a Web page. Additionally, the regional meta-data notified as a candidate can be the information about the region for which the Web page is accessed at a relatively high frequency. Therefore, the author can also customize the Web page for a specific region according to the notified regional meta-data.

Thus, the Web regional information retrieval apparatus 10 promotes an author adding meta-data to a Web page. The meta-data added by the author is used in the process of extracting the above-mentioned meta-data. By promoting the addition of meta-data, the retrieval precision and the utility of the information in the WWW can be improved.

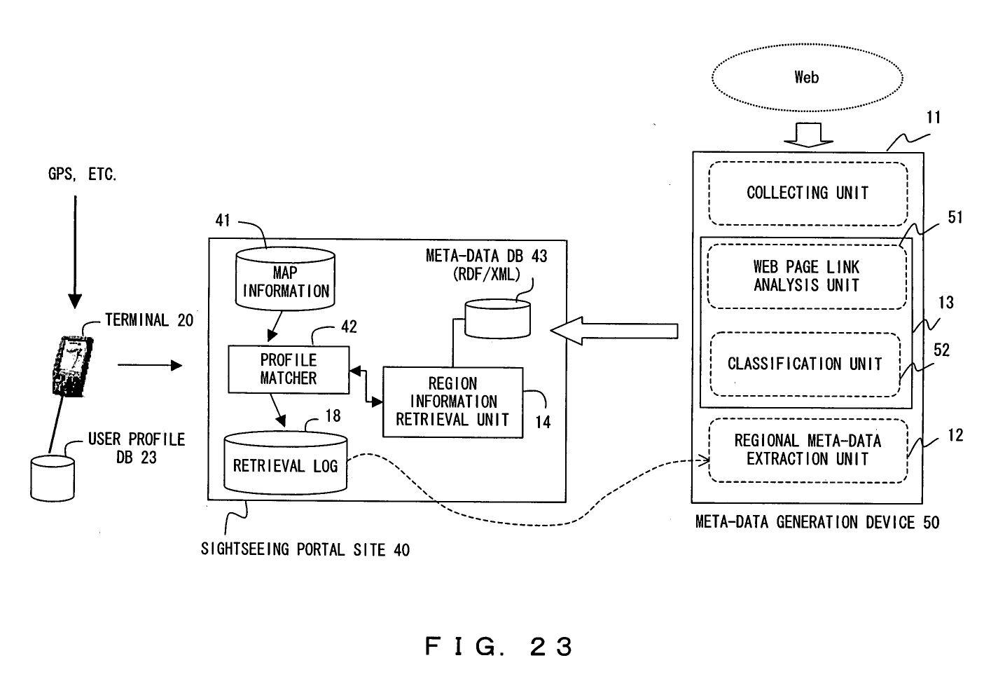

Described below is the second embodiment of the present invention. FIG. 23 is a block diagram showing the function of the sightseeing portal site according to the second embodiment. As shown in FIG. 23, the sightseeing portal site 40 is connected to the terminal 20 of a user and a meta-data generation device 50 over a network not shown in the attached drawings. It is obvious that the sightseeing portal site 40 and the meta-data generation device 50 can be provided in the same apparatus.

The terminal 20 has the function of obtaining location information using the above-mentioned GPS, the radio technology, etc. Additionally, the terminal 20 comprises a user profile DB 23 storing a user profile. The user transmits the location information, the user profile, and a retrieval request from the terminal 20 to the sightseeing portal site 40 when the user retrieves information from the WWW. A retrieval request can be a category, a keyword, etc.

The sightseeing portal site 40 retrieves a Web page from the WWW based on the location information, the retrieval request, and the user profile, and transmits the retrieval result to the terminal 20. When transmitting the retrieval result to the terminal 20, the sightseeing portal site 40 marks the location indicated by the location information and the location indicated by the regional meta-data added to the Web page on the map. Furthermore, the sightseeing portal site 40 obtains the retrieval result and the log accessed by the user. To attain this, the sightseeing portal site 40 comprises a map information DB 41, a profile matcher 42, the region information retrieval unit 14, a meta-data DB 43, and the retrieval log 18.

The map information DB 41 stores the map information indicating the map. The profile matcher 42 determines the retrieval result adaptable to the user profile received from the terminal 20, and transmits the retrieval result determined as adaptable. In the retrieval result, the location indicated by the regional meta-data of the Web page obtained by the retrieval and the location indicated by the location information are marked on the map. Furthermore, the profile matcher 42 writes the above-mentioned log to the retrieval log 18. Since the process of the profile matcher 42 determining the retrieval result matching the user profile is well known, and the explanation is omitted here. A meta-data DB 44 stores the meta-data received from the meta-data generation device 50. The region information retrieval unit 14 and the retrieval log 18 are described above.

The meta-data generation device 50 collects a Web page from the WWW, adds the meta-data to the collected Web page, and transmits the added data to the sightseeing portal site 40. To attain this, the meta-data generation device 50 comprises the collecting unit 11, the regional meta-data extraction unit 12, and the popularity-class assignment unit 13. The collecting unit 11, the regional meta-data extraction unit 12, and the popularity-class assignment unit 13 are described above. The collecting unit 11 can be configured such that it collects especially the information about the area emphasized by the sightseeing portal site 40, for example, the sightseeing spots in Kyoto, etc.

A Web page link analysis unit 51 and a classification unit 52, in the popularity-class assignment unit 13 in FIG. 23, calculates the popularity of each Web page by analyzing the link relation between Web pages, and classifies the category of the Web page based on the keyword in the text of the Web page. The analysis and the classification of the link relation are well known. The meta-data added to a Web page by the meta-data generation device 50 is also described above.

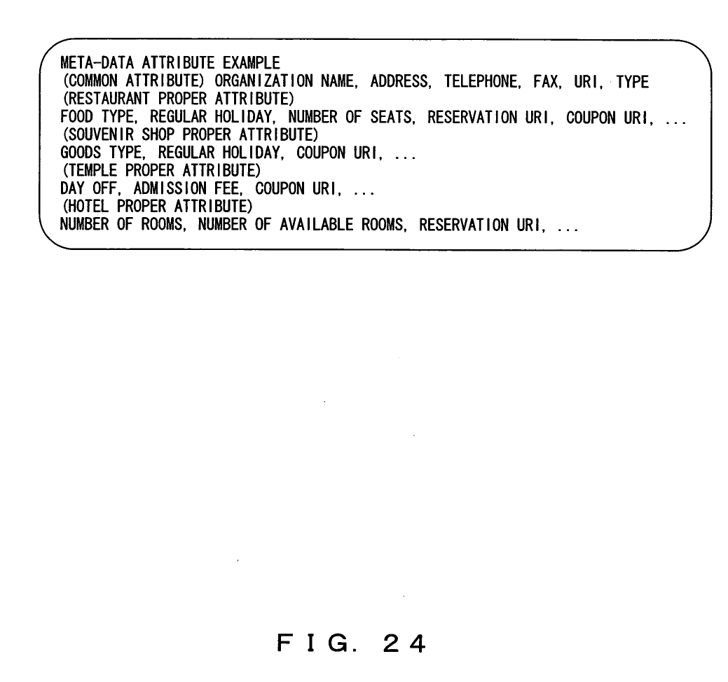

Described below is the attribute of the meta-data collected by the meta-data generation device 50. The meta-data generation device 50 collects the meta-data of a collected Web page such as regional meta-data, a title, explanation, etc. The meta-data generation device 50 can obtain further meta-data in addition to the above-mentioned meta-data from the text of the Web page depending on the use of the sightseeing portal site 40. FIG. 24 shows an example of the attribute of meta-data obtained by the meta-data generation device 50 depending on the use of the sightseeing portal site 40.

As shown in FIG. 24, the attributes of the meta-data extracted from all Web pages by the meta-data generation device 50 can be, for example, “organization name”, “address”, “phone number”, “facsimile number”, “URI of Web page”, “type of the contents of a Web page”, etc.

For example, when the type of the contents of a Web page is “restaurant”, a further attribute of the meta-data to be extracted from the Web page can be “cooking type”, “regular holiday”, “number of seats”, “URI of Web page for reservation”, “URI of Web page for issue of coupon”, etc.

Furthermore, for example, when the type of the contents of a Web page is “souvenir shop”, the attribute of the meta-data extracted from a Web page by the meta-data generation device 50 can be “type of goods”, “regular holiday”, “URI of Web page for issue of coupon”, etc.

Additionally, for example, when the type of the contents of a Web page is “hotel”, the attribute of the meta-data to be extracted from a Web page can be “number of rooms”, “number of available rooms”, “URI of Web page for reservation”, etc.

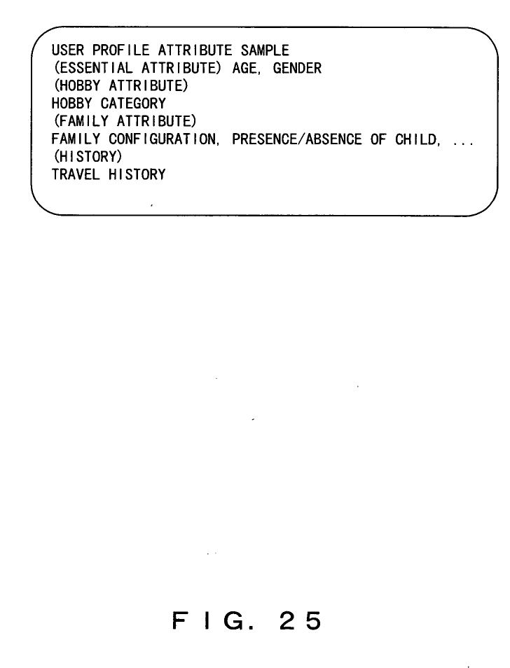

An example of the attribute of data contained in the user profile stored in the user profile DB 23 is explained below by referring to FIG. 25. As shown in FIG. 25, the attribute essential to the data contained in a user profile can be, for example, the age group such as teens, twenties, etc., gender, etc. Other attributes can be the category of the hobby of a user, the configuration of a family, the presence/absence of a child, the history of travel, etc.

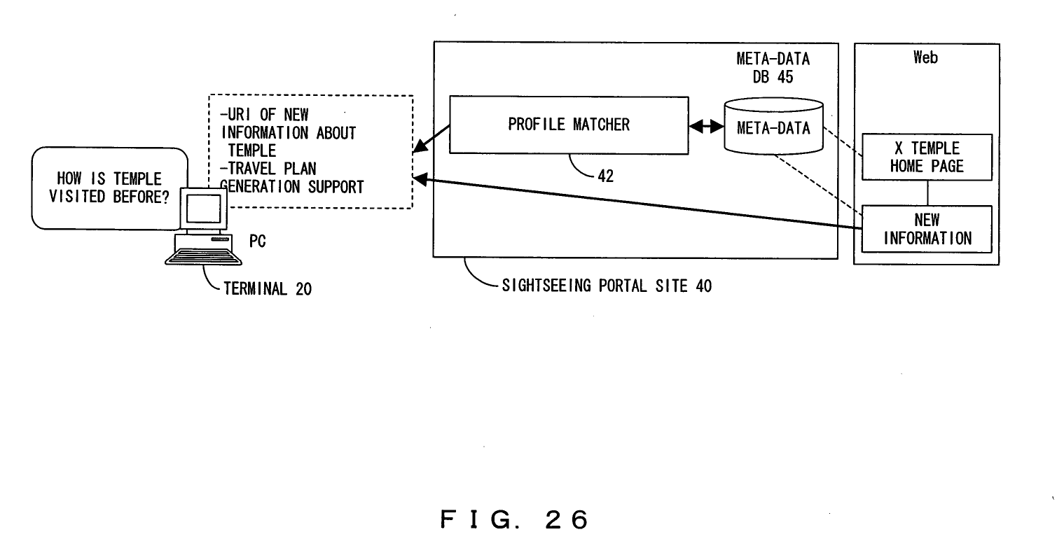

Described below is the procedure of retrieving information by the sightseeing portal site 40. First, the case in which a user uses the sightseeing portal site 40 in retrieving information in the WWW before starting traveling is described below by referring to FIG. 26. For explanation, it is assumed that the user profile DB 23 of the terminal 20 stores the history of travel to the X temple, and the user is obtaining the information about “what is the old traveling route like”.

The terminal 20 of the user transmits a retrieval request “what is the old traveling route like” together with a user profile to the sightseeing portal site 40. As shown in FIG. 26, the region information retrieval unit 14 and the profile matcher 42 in the sightseeing portal site 40 obtain the URI of the new information from the home page of the X temple based on the history of travel about the X temple, and transmits the result to the terminal 20. Furthermore, the sightseeing portal site 40 obtains from the meta-data DB 45, etc., the information for support of preparing a travel plan including the admission fee for the X temple, the transportation fee to the temple, etc., and transmits the obtained information to the terminal 20.

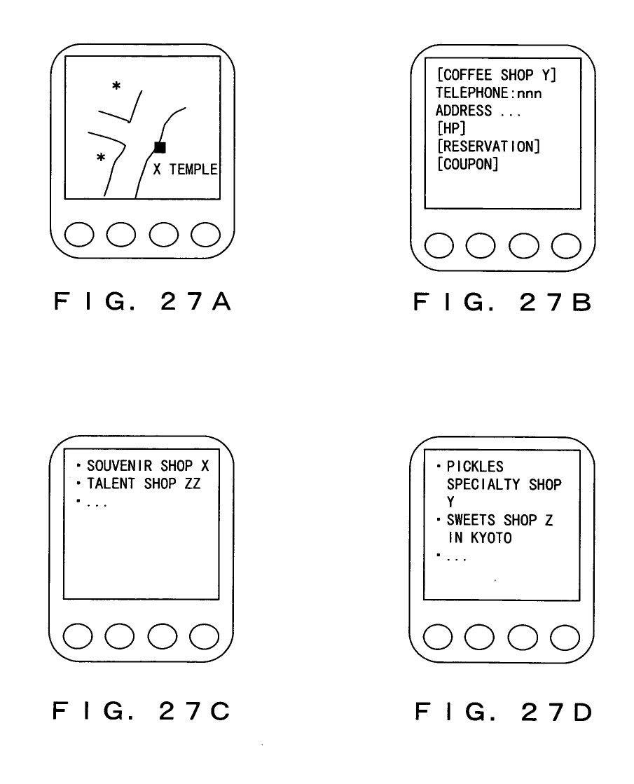

The case in which a traveling user uses the sightseeing portal site 40 to retrieve the information in the WWW is described below by referring to FIGS. 27A, 27B, 27C and 27D. First, the case in which a traveling user requests the sightseeing portal site 40 to retrieve the information about a “restaurant in the vicinity” is described below.

In this case, first, the terminal 20 of the user transmits the location information obtained from the GPS, etc. and the retrieval request “to be informed of a restaurant in the vicinity to the sightseeing portal site 40. The region information retrieval unit 14 in the sightseeing portal site 40 searches the meta-data DB 43 using the location information and the category “restaurant” as a retrieval key, and obtains the Web page which has the regional meta-data indicating the region near the location indicated by the location information, and is classified as a category “restaurant”. Then, the profile matcher 42 obtains the map information about the region including the location indicated by the location information from the map information DB 41, generates the screen displaying the location or the region indicated by the regional meta-data of the Web page and the location indicated by the location information on the map of the region including the region based on the map information, the location information, and the regional meta-data relating to the retrieved Web page, and displays the screen on the display unit of the terminal 20.

FIG. 27A shows an example of the display screen as a retrieval result. In FIG. 27A, the current location of the terminal 20 indicated by the location information is marked by the black square (▪) on the map, and the location of the “restaurant in the vicinity” obtained as a result of the retrieval is indicated by the asterisk (*).

When the user selects (clicks) the location of any of the restaurants indicated as a retrieval result on the screen shown in FIG. 27A, the region information retrieval unit 14 obtains the meta-data relating to the selected restaurant from the meta-data DB 43, and displays it on the display unit of the terminal 20.

FIG. 27B shows an example of the display screen of the meta-data corresponding to the selected location. In FIG. 27B, the telephone number, the address, the URI of the home page of the “coffee shop Y”, the URI of the Web page for reservation, the URI of the Web page for issue of a coupon, etc. are shown. Each URI stores the link to the corresponding Web page. When a user selects any of the URIs, the Web page corresponding to the URI is displayed on the display unit of the terminal 20.

Described below is the case in which a traveling user requests the sightseeing portal site 40 to retrieve the information about the souvenir shops for the traveling user's taste in the vicinity.

In this case, the terminal 20 of the user transmits the location information obtained using the GPS, etc., the user profile, and the retrieval request “to buy a souvenir in the vicinity of the current location” to the sightseeing portal site 40. The region information retrieval unit 14 in the sightseeing portal site 40 searches the meta-data DB 43 using the location information and the category “souvenir” as a retrieval key, and obtain the Web page which has regional meta-data indicating the location or region near the location indicated by the location information, and is classified as a category “souvenir”. Then, the profile matcher 42 sorts the retrieval result such that the Web page which is estimated to match the taste of the user can be the leading page in the obtained Web pages based on the user profile, and displays on the display unit of the terminal 20 the URIs of the retrieved Web pages in the order in which they are sorted.

FIG. 27C shows an example of the screen displayed on the terminal 20 when the user profile indicates “the user is in his/her forties and has children”. FIG. 27D shows an example of the screen displayed on the terminal 20 when the user profile indicates “the user is in his/her twenties and has a hobby relating to gourmet”. As shown in FIGS. 27C and 27D, the terminal 20 of the user who is in his/her forties and has children displays the retrieval result with the information about a souvenir shop as the leading page while the terminal 20 of the user who is in his/her twenties and has the hobby relating to gourmet displays the retrieval result with the information about a food specialty shop as the leading page.

Thus, according to the sightseeing portal site 40 of the second embodiment, the Web pages relating to the location or region are obtained from the WWW according to the location information indicating the geographical location, and the retrieval result can be provided for the user depending on the taste of the user.

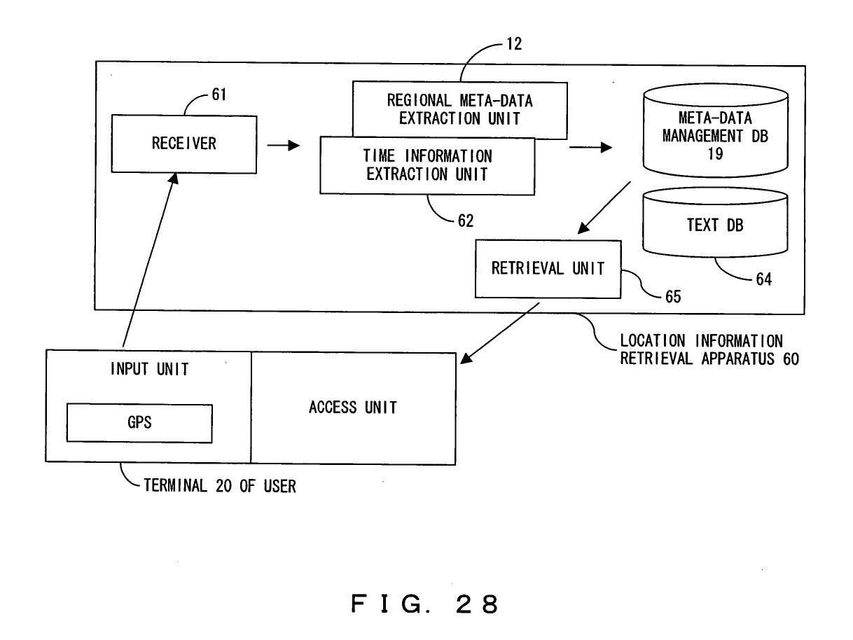

Described below is the third embodiment of the present invention. FIG. 28 is a block diagram showing the function of the location information retrieval apparatus according to the third embodiment of the present invention. As shown in FIG. 28, a location information retrieval apparatus 60 is connected to the terminal 20 of the user over a network not shown in the attached drawings.

The terminal 20 has the function of obtaining the location information using the above-mentioned GPS, the radio technology, etc., an input unit, and an access unit. When information is to be registered in the location information retrieval apparatus 70, the user inputs the information in a memo, etc. using the input unit, and transmits using the access unit the input information together with the location information and the input date and time information indicating the input date and time to the location information retrieval apparatus 60. Furthermore, when the information stored in the location information retrieval apparatus 60 is to be retrieved, the user inputs a retrieval request using the input unit, and transmits the retrieval request to the location information retrieval apparatus 60 using an accessing unit.

The location information retrieval apparatus 60 receives the information in a memo, etc. to be registered from the terminal of the user, extracts the date and time meta-data relating to the date and time and the regional meta-data from the received information to be registered, and manages the location information, the extracted date and time meta-data and the regional meta-data with the information to be registered associated with the data to be registered. Then, at an instruction of the user, it retrieves managed information.

To attain this, the location information retrieval apparatus 60 comprises a receiver 61, the regional meta-data extraction unit 12, a time information extraction unit 62, the meta-data management DB 19, and a retrieval unit 65.

The receiver 61 receives information from the terminal of the user, and outputs the received information to the regional meta-data extraction unit 12 and the time information extraction unit 62. The regional meta-data extraction unit 12 extracts regional meta-data from the information to be registered, associates the data with the information to be registered, and writes the extracted regional meta-data to the meta-data management DB 19. The process performed by the regional meta-data extraction unit 12 is explained above.

The time information extraction unit 62 extracts the date and time meta-data from the information to be registered. Since the process performed by the time information extraction unit 62 has been disclosed in the Japanese Patent Application Laid-open No. Hei 10-283365, the explanation is omitted here.

The meta-data management DB 19 according to the third embodiment of the present invention stores meta-data as with the meta-data management DB 19 according to the first embodiment. The difference between them is that the meta-data management DB 19 according to the third embodiment stores the meta-data extracted from the information to be registered, and stores the date and time meta-data table (not shown in the attached drawings) instead of the popularity table 191. The data structure of the date and time meta-data table is different from that of the regional meta-data table 193 only in that the information about the date and time is stored instead of the information about the region. Basically, since it has the same data structure as the regional meta-data table shown in FIG. 11, the explanation is omitted here.

A text DB 64 stores the information to be registered and the ID for identification of the information to be registered. Since the data structure of the text DB 64 is self-explanatory, it is omitted here.

The retrieval unit 65 retrieves the user input information according to a retrieval request and location information. Since the process performed by the retrieval unit 65 is the same as that of the region information retrieval unit 14, the explanation is omitted here.

The procedure of retrieving the information using the location information retrieval apparatus 60 is described below. First, the user selects the information to be registered in the location information retrieval apparatus 60 using an input unit from the information generated by the user and the information browsed using a browser and a mailer. When the information to be registered is selected, the access unit transmits the information to be registered, the input date and time information, and the location information to the location information retrieval apparatus 60.

The receiver 61 writes the input date and time information and the location information in the received data to the meta-data management DB 19 and writes the information to be registered to the text DB 64. Furthermore, the receiver 61 outputs the information to be registered to the regional meta-data extraction unit 12 and the time information extraction unit 62.

The regional meta-data extraction unit 12 extracts the regional meta-data from the information to be registered, and stores the extracted regional meta-data in the meta-data management DB 19. For example, when the information “ . . . in Hongo in Bunkyo Ward of Tokyo” is contained in the information to be registered, the regional meta-data extraction unit 12 extracts “Tokyo/Bunkyo Ward/Hongo” as regional meta-data.

The time information extraction unit 62 extracts date and time meta-data from the information to be registered, and stores the extracted date and time meta-data in the meta-data management DB 19. For example, when the information “The deadline of subscribed theses is Friday, Jan. 13, 2002.” is contained in the information to be registered, the time information extraction unit 62 extracts “2002/01/13” as date and time meta-data from the information to be registered.

Thus, the location information retrieval apparatus 60 stores received information to be registered and the meta-data relating to the information in the DB.

When a retrieval request is received from a user, the date and time meta-data, the regional meta-data, the keyword, etc. stored in the meta-data management DB 19 are referred to based on the retrieval request, and the ID of information to be registered having the matching meta-data with the retrieval request is obtained. Then, based on the obtained ID, the information to be registered corresponding to the ID is obtained from the text DB 64, and the obtained information to be registered is transmitted to the terminal 20 as a retrieval result.

For example, when the retrieval unit 65 receives the retrieval request “to be informed of a Web page read during the business trip in the western district several months ago”, the information to be registered which has the input date and time information or the date and time meta-data indicating “several months ago” and has the location information or the regional meta-data indicating “western district” can be retrieved from the text DB 64.

Similarly, the retrieval unit 65 can retrieve the information to be registered from the text DB 64 based on the retrieval request “to contain the keyword ‘Java (registered trademark)’ in the memo generated at home last week”.

According to the third embodiment, manifold information can be retrieved based on the location information indicating the geographical location, and the information relating to the location or the region can be obtained.

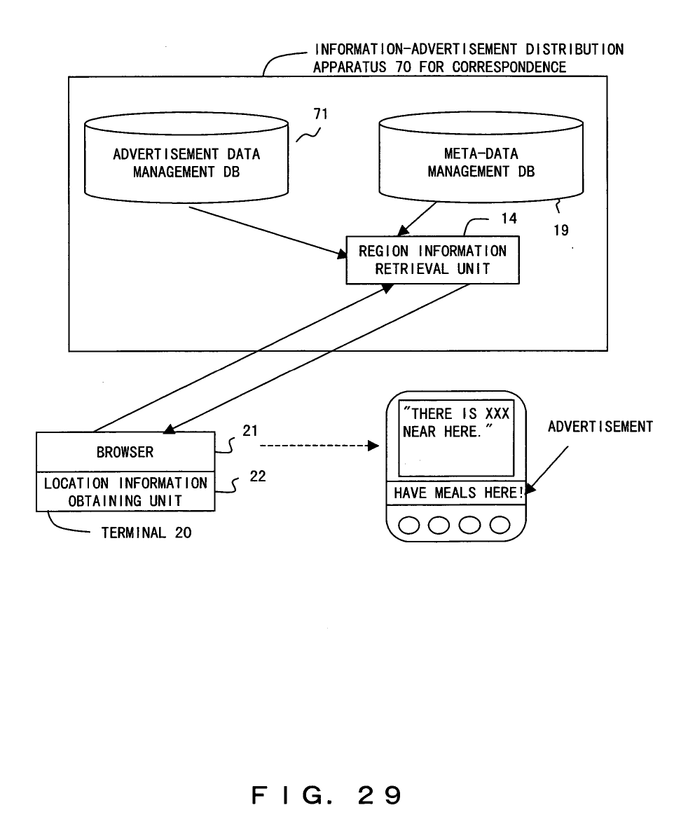

The fourth embodiment of the present invention is explained below. FIG. 29 shows an information-advertisement distribution apparatus 70 relating to the location according to the fourth embodiment of the present invention. As shown in FIG. 29, the information-advertisement distribution apparatus 70 is connected to the terminal 20 of the user over a network not shown in the attached drawings.

The terminal 20 comprises the browser 21 and the location information obtaining unit 22. When a user requests to retrieve information, the user inputs a retrieval request with a category, a keyword, etc. to the terminal 20. The terminal 20 transmits the retrieval request and the location information to the information-advertisement distribution apparatus 70. When the terminal 20 has the above-mentioned user profile DB, the terminal 20 can transmit the user profile to the information-advertisement distribution apparatus 70 together with the retrieval request and the location information.

The information-advertisement distribution apparatus 70 retrieves information according to the information received from the terminal 20, and distributes the advertisement information for advertisement of a shop relating to the retrieval result. To attain this, the information-advertisement distribution apparatus 70 comprises the collecting unit 11, the regional meta-data extraction unit 12, the popularity-class assignment unit 13, the region information retrieval unit 14, an advertisement data management DB 71, and the meta-data management DB 19. In FIG. 29, the collecting unit 11, the regional meta-data extraction unit 12, and the popularity-class assignment unit 13 are omitted. Furthermore, the collecting unit 11, the regional meta-data extraction unit 12, the popularity-class assignment unit 13, the region information retrieval unit 14, and the meta-data management DB 19 are described above.

The advertisement data management DB 71 stores the advertisement information about the advertising contents of each shop and the regional meta-data, the keyword, etc. about each shop. When the user profile is received from the terminal 20 together with the retrieval request and the location information, the information-advertisement distribution apparatus 70 can further comprise a profile matcher in addition to the configuration above.

Described below is the procedure of distributing the information using the information-advertisement distribution apparatus 70. First, the terminal 20 transmits a retrieval request and location information to the information-advertisement distribution apparatus 70.

The region information retrieval unit 14 of the information-advertisement distribution apparatus 70 searches the meta-data management DB 19 according to the retrieval request and the location information as described above, and transmits a link to the Web page obtained as a retrieval result to the terminal 20. Furthermore, the region information retrieval unit 14 searches the advertisement data management DB 71 according to the retrieval request and the location information, and transmits the advertisement information obtained as a retrieval result to the terminal 20.

When a user transmits a user profile to the information-advertisement distribution apparatus 70 in addition to the retrieval request and the location information, the information-advertisement distribution apparatus 70 further performs the process of sorting the retrieval results and the advertisement information obtained as described above using a profile matcher.

For example, when a retrieval request “to buy souvenir in the vicinity” and location information are received from the terminal 20, the information-advertisement distribution apparatus 70 displays a link to the Web page about a souvenir shop near the location information as in the second embodiment. Furthermore, the information-advertisement distribution apparatus 70 outputs voice, a character string, an image, etc. for advertisement of the shop to the terminal 20 according to the retrieved advertisement information.

Described below is a variation of the information-advertisement distribution apparatus 70 according to the fourth embodiment. In the explanation above, the information-advertisement distribution apparatus 70 outputs advertisement information to the terminal 20 of a user when it transmits a retrieval result to the terminal 20 of the user. However, the information-advertisement distribution apparatus 70 can output the retrieval result of the Web page relating to the location and the advertisement information about the shop relating to the location when the terminal 20 reaches a predetermined location.

The configuration of the information-advertisement distribution apparatus 70 according to a variation of the fourth embodiment is the same as that according to the fourth embodiment of the present invention. However, the information-advertisement distribution apparatus 70 receives the location information at predetermined intervals. When the location indicated by the location information is a specific location or in a specific region, the information-advertisement distribution apparatus 70 outputs a link to a Web page having regional meta-data relating to the specific location or region and the advertisement information to the terminal 20. The advertisement corresponds to a handbill distributed on the street in an electronic form.

In the variation according to the fourth embodiment of the present invention, the information-advertisement distribution apparatus 70 can comprise the profile matcher 42 and the user profile DB 23. In this case, the information-advertisement distribution apparatus 70 receives location information from the terminal 20. Then, in the information-advertisement distribution apparatus 70, the profile matcher 42 obtains a user profile of the user of the terminal 20 from the user profile DB 23, sorts the retrieval results by the region information retrieval unit 14 based on the user profile, and outputs the sorted retrieval result to the terminal 20. The user profile DB 23 can be comprised in the terminal 20, not in the information-advertisement distribution apparatus 70. In this case, the information-advertisement distribution apparatus 70 receives the location information and the user profile from the terminal 20.

According to the fourth embodiment and a variation, the information in the WWW can be retrieved according to the location information indicating a geographical location, and the advertisement relating to the location can be transmitted to the user. So that, a useful retrieval result can be presented to the user, and the advertisement of a shop near the user can be outputed to the terminal of the user, thereby performing an effective advertisement.

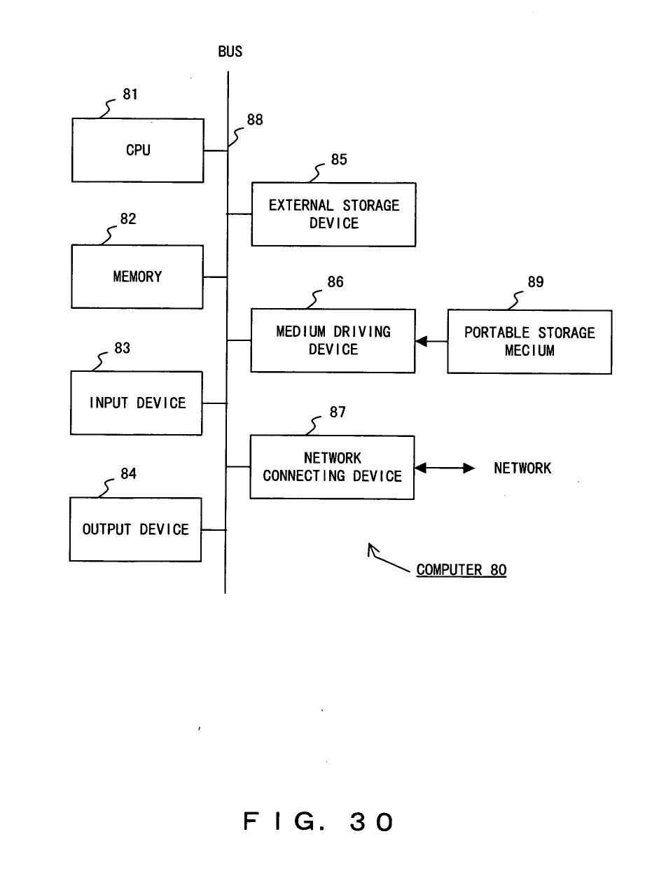

The terminal 20 of a user, the terminal 30 of an author, the Web regional information retrieval apparatus 10, the sightseeing portal site 40, the meta-data generation device 50, the location information retrieval apparatus 60, and the information-advertisement distribution apparatus 70 described above in the embodiments of the present invention can be configured using the computer (information processing device) as shown in FIG. 30. As shown in FIG. 30, a computer 80 comprises a CPU 81, memory 82, an input device 83, an output device 84, an external storage device 85, a medium drive device 86, and a network connection device 87. These components are interconnected through a bus 88.

The memory 82 includes, for example, ROM (read only memory), RAM (random access memory), etc., and stores a program and data used in processing. The CPU 81 performs a necessary process by executing a program using the memory 82.

For example, when the above-mentioned Web regional information retrieval apparatus 10 is configured using the computer 80, the collecting unit 11, the regional meta-data extraction unit 12, the popularity-class assignment unit 13, and the region information retrieval unit 14 forming the above-mentioned Web regional information retrieval apparatus 10 are stored as programs in the respective program code segments in the memory 82. Otherwise, when the above-mentioned sightseeing portal site 40 is configured using the computer 80, the region information retrieval unit 14 and the profile matcher 42 are stored as programs in the specific program code segments of the memory 82 of the computer 80.

Similarly, when the meta-data generation device 50, the location information retrieval apparatus 60, and the information-advertisement distribution apparatus 70 are configured using the computer 80, the component forming each device is stored as a program in the specific program code segment of the memory 82. The process performed by each unit is described above by referring to the flowchart.

The input device 83 can be, for example, a button, a dial, a keyboard, a pointing device, a touch panel, etc., and used in inputting an instruction and information from a user. The output device 84 can be, for example, a speaker, a display, a printer, etc., and is used in issuing an inquiry to a user from the computer 80, and outputting a process result, etc.

The external storage device 85 can be, for example, a magnetic disk device, an optical disk device, a magneto-optical disk, etc. The external storage device 85 realizes distribution rejection DB 5 and registration information DB 6. The external storage device 85 can store the above-mentioned program which can be loaded to the memory 82 as necessary.

The medium drive device 86 drives a portable storage device 89 and accesses the stored contents. The portable storage device 89 can be any computer-readable storage medium such as a memory card, a memory stick, a floppy disk, CD-ROM (compact disk read only memory), optical disk, a magneto-optical disk, a DVD (digital versatile disk), etc. The portable storage device 89 can store the above-mentioned program which can be loaded to the memory 82 as necessary.

The network connection device 87 communicates with an external device over any network N (circuit) such as a LAN, a WAN, etc., and converts data for use in communications, and receives the program and data from the external device as necessary, and loads them into the memory 82 for use.

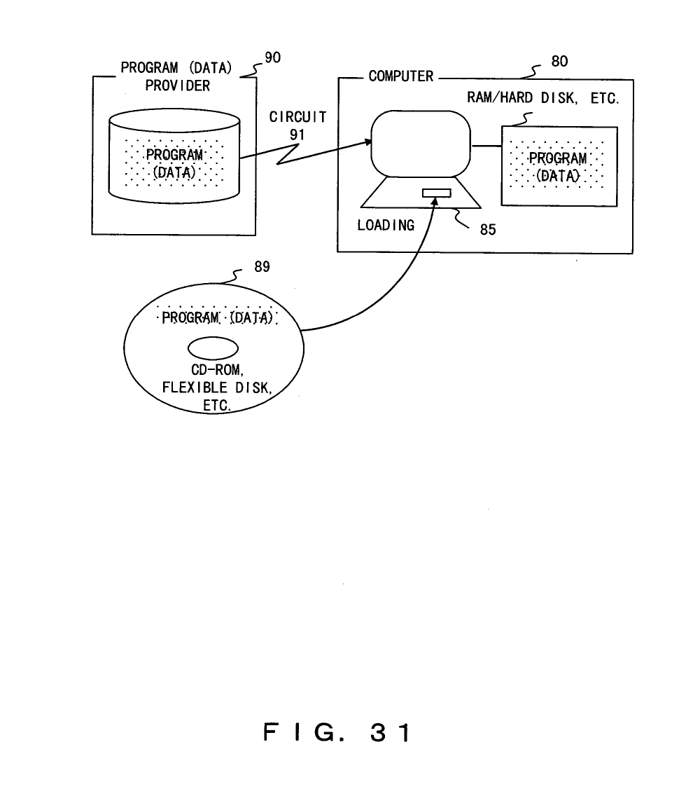

FIG. 31 shows a computer-readable record medium and transmission signal that can provide the program and data for the computer 30 in FIG. 30.

The functions corresponding to terminal 20, the terminal 30 of an author, the Web regional information retrieval apparatus 10, the sightseeing portal site 40, the meta-data generation device 50, the location information retrieval apparatus 60, and the information-advertisement distribution apparatus 70 can be performed by a general-purpose computer. To attain this, a plurality of programs to direct a computer to perform the processes similar to those performed by the terminal 20, the terminal 30 of the author, the Web regional information retrieval apparatus 10, the sightseeing portal site 40, the meta-data generation device 50, the location information retrieval apparatus 60, and the information-advertisement distribution apparatus 70 are generated.

That is, the program for the terminal 20, the program for the Web regional information retrieval apparatus 10, the program for a sightseeing portal site, etc. are generated. Each program is stored in the computer-readable portable storage device 89. Furthermore, as shown in FIG. 31, each program is read from the portable storage device 89 by each computer 80, temporarily stored in the memory 82 of the computer 80 or in the external storage device 85, and read and executed by the CPU 81 of the computer 80.

A transmission signal transmitted through a circuit 91 when the program is downloaded to the computer 80 from a program (data) provider 90 can be realized by a general-purpose computer by performing the functions corresponding to each of the terminal 20, the terminal 30 of an author, the Web regional information retrieval apparatus 10, the sightseeing portal site 40, the meta-data generation device 50, the location information retrieval apparatus 60, and the information-advertisement distribution apparatus 70.

Instead of allowing the computer to read the program from the portable storage device 89, the program can be downloaded from the database of the program (data) provider 90 through the communications circuit 91. In this case, for example, in the transmitting computer of the program (data) provider 90, the program data representing the above-mentioned program can be converted into a program data signal, a transmission signal is obtained by modulating a program data signal converted using a modem, the obtained transmission signal is output to the circuit 91 (transmission medium). In the computer for receiving a program, the received transmission signal is demodulated using a modem to obtain a program data signal, and the obtained program data signal is converted, thereby obtaining program data. When the communications circuit 91 (transmission medium) between the transmitting computer and the receiving computer is a digital circuit, a program data signal can be communicated. There can be a computer such as a telephone station, etc. between the program transmitting computer and the program downloading computer.

The embodiments of the present invention have been described above, but the present invention is not limited to the above-mentioned embodiments, and can be realized as many other variations.

1. A Web page retrieving method in which a computer retrieves a Web page which is information in a Worldwide Web, comprising:
extracting regional meta-data indicating a region related to a Web page;
assigning the regional meta-data to the Web page; and
retrieving a Web page assigned the regional meta-data related to location information indicating a geographical location from the Worldwide Web.

2. The method according to claim 1, wherein
said regional meta-data is extracted based on representation indicating a region contained in text of a Web page.

3. The method according to claim 2, wherein
said regional meta-data is extracted based on representation indicating a region contained in text of a Web page which is a linked page of another Web page.

4. The method according to claim 3, wherein
said regional meta-data is extracted according to flag information indicating a location of a Web page in the Worldwide Web.

5. The method according to claim 4, wherein
said regional meta-data is extracted based on a link relation between Web pages.

6. The method according to claim 5, wherein
said regional meta-data is extracted based on past retrieval results of Web pages.

7. The method according to claim 6, wherein
said retrieval results are sorted according to the regional meta-data and location information.

8. The method according to claim 7, wherein
when the regional meta-data is assigned to the Web page by an author of the Web page, at least a part of the past retrieval results of the Web pages is presented.

9. The method according to claim 8, wherein
when a Web page is generated or updated, a candidate for the regional meta-data to be assigned to the Web page is extracted; and
said candidate for the regional meta-data is transmitted to an author of the Web page.

10. The method according to claim 9, wherein
advertisement information indicating contents to be advertised and the regional meta-data relating to the advertisement information are stored in a storage unit;
advertisement information having the regional meta-data relating to the location information is obtained from said storage unit; and
the obtained advertisement information is transmitted to a terminal which transmits the location information.

11. A meta-data assignment support method, comprising:
extracting a candidate of regional meta-data indicating a region relating to a Web page which is information in a Worldwide Web when the Web page is generated or updated; and
transmitting the candidate for the regional meta-data to an author of the Web page.

12. An information arranging method, comprising:
receiving information to be registered which is information to be registered in a storage unit, and location information indicating a location of a terminal from the terminal;
extracting regional meta-data indicating a region relating to the information to be registered;
storing the information to be registered, the regional meta-data, and the location information in said storage unit with the information and data associated with one another; and
when a retrieval request relating to a region is received, retrieving the information to be registered corresponding to the regional meta-data relating to the retrieval request from said storage unit.

13. A Web page retrieval apparatus, comprising:
a regional meta-data extraction unit extracting regional meta-data indicating a region related to a Web page which is information in a Worldwide Web, and assigning the regional meta-data to the Web page; and
a regional information retrieval unit retrieving a Web page assigned the regional meta-data related to location information indicating a geographical location from the Worldwide Web.

14. A meta-data assignment support apparatus, comprising:
a regional meta-data extraction unit extracting a candidate for regional meta-data indicating a region related to a Web page which is information in a Worldwide Web when the Web page is generated or updated; and
a regional meta-data notification unit transmitting the candidate for the regional meta-data to an author of the Web page.

15. An information management apparatus, comprising:
a reception unit receiving text indicating contents to be registered, location information indicating a location of a terminal, and a retrieval request relating to a region from the terminal;
a regional meta-data extraction unit extracting regional meta-data indicating a region related to the text when said reception unit receives the text and the location information;
a storage unit storing the text, the regional meta-data, and the location information with the text, the data, and the information associated with one another; and
a retrieval unit retrieving the text corresponding to the regional meta-data related to the retrieval request from said storage unit when said reception unit receives a retrieval request relating to the region.

16. A computer-readable record medium storing a program used to direct a computer to perform a process of retrieving information, comprising:
extracting regional meta-data indicating a region related to a Web page which is information in a Worldwide Web;
assigning the regional meta-data to the Web page; and
retrieving a Web page assigned the regional meta-data related to location information indicating a geographical location from the Worldwide Web.

17. A computer-readable record medium storing a program used to direct a computer to perform a process of supporting assigning meta-data to information, comprising:
extracting a candidate of regional meta-data indicating a region relating to a Web page which is information in a Worldwide Web when the Web page is generated or updated; and
transmitting the candidate for the regional meta-data to an author of the Web page.

18. A computer-readable record medium storing a program used to direct a computer to perform a process of managing information, comprising:
receiving text indicating contents to be registered, and location information indicating a location of a terminal from the terminal;
extracting regional meta-data indicating a region relating to the text;
storing the text, the regional meta-data, and the location information in a storage unit with the text, the data, and the information associated with one another; and
retrieving the text corresponding to the regional meta-data relating to the retrieval request from said storage unit when a retrieval request relating to a region is received.

19. A program used to direct a computer to perform a process of retrieving information, comprising:
extracting regional meta-data indicating a region related to a Web page which is information in a Worldwide Web;
assigning the regional meta-data to the Web page; and
retrieving a Web page assigned the regional meta-data related to location information indicating a geographical location from the Worldwide Web.

20. A program used to direct a computer to perform a process of supporting assignment of meta-data to information;
extracting a candidate of regional meta-data indicating a region relating to a Web page which is information in a Worldwide Web when the Web page is generated or updated; and
transmitting the candidate for the regional meta-data to an author of the Web page.

21. A program used to direct a computer to perform a process of managing information, comprising:
receiving text indicating contents to be registered, and location information indicating a location of a terminal from the terminal;
extracting regional meta-data indicating a region relating to the text;
storing the text, the regional meta-data, and the location information in a storage unit with the text, the data, and the information associated with one another; and
retrieving the text corresponding to the regional meta-data relating to the retrieval request from said storage unit when a retrieval request relating to a region is received.

22. A retrieving method, comprising:
obtaining location information indicating a current location;
transmitting a retrieval request for retrieval of a Web page which is information in a Worldwide Web to said server together with the location information; and
receiving information relating to a Web page retrieved according to the retrieval request and the location information.

23. The method according to claim 8, wherein
advertisement information indicating contents to be advertised and the regional meta-data relating to the advertisement information are stored in a storage unit;
advertisement information having the regional meta-data relating to the location information is obtained from said storage unit; and
the obtained advertisement information is transmitted to a terminal which transmits the location information.

24. The method according to claim 7, wherein
when a Web page is generated or updated, a candidate for the regional meta-data to be assigned to the Web page is extracted; and
said candidate for the regional meta-data is transmitted to an author of the Web page.

25. The method according to claim 7, wherein
advertisement information indicating contents to be advertised and the regional meta-data relating to the advertisement information are stored in a storage unit;
advertisement information having the regional meta-data relating to the location information is obtained from said storage unit; and
the obtained advertisement information is transmitted to a terminal which transmits the location information.

26. The method according to claim 6, wherein
when the regional meta-data is assigned to the Web page by an author of the Web page, at least a part of the past retrieval results of the Web pages is presented.

27. The method according to claim 6, wherein
when a Web page is generated or updated, a candidate for the regional meta-data to be assigned to the Web page is extracted; and
said candidate for the regional meta-data is transmitted to an author of the Web page.

28. The method according to claim 6, wherein
advertisement information indicating contents to be advertised and the regional meta-data relating to the advertisement information are stored in a storage unit;
advertisement information having the regional meta-data relating to the location information is obtained from said storage unit; and
the obtained advertisement information is transmitted to a terminal which transmits the location information.

29. The method according to claim 5, wherein
said retrieval results are sorted according to the regional meta-data and location information.

28. The method according to claim 5, wherein
when the regional meta-data is assigned to the Web page by an author of the Web page, at least a part of the past retrieval results of the Web pages is presented.

29. The method according to claim 5, wherein
when a Web page is generated or updated, a candidate for the regional meta-data to be assigned to the Web page is extracted; and
said candidate for the regional meta-data is transmitted to an author of the Web page.

30. The method according to claim 5, wherein
advertisement information indicating contents to be advertised and the regional meta-data relating to the advertisement information are stored in a storage unit;
advertisement information having the regional meta-data relating to the location information is obtained from said storage unit; and
the obtained advertisement information is transmitted to a terminal which transmits the location information.

31. The method according to claim 4, wherein
said regional meta-data is extracted based on past retrieval results of Web pages.

32. The method according to claim 4, wherein
said retrieval results are sorted according to the regional meta-data and location information.

33. The method according to claim 4, wherein
when the regional meta-data is assigned to the Web page by an author of the Web page, at least a part of the past retrieval results of the Web pages is presented.

34. The method according to claim 4, wherein
when a Web page is generated or updated, a candidate for the regional meta-data to be assigned to the Web page is extracted; and
said candidate for the regional meta-data is transmitted to an author of the Web page.

35. The method according to claim 4, wherein
advertisement information indicating contents to be advertised and the regional meta-data relating to the advertisement information are stored in a storage unit;
advertisement information having the regional meta-data relating to the location information is obtained from said storage unit; and
the obtained advertisement information is transmitted to a terminal which transmits the location information.

36. The method according to claim 3, wherein
said regional meta-data is extracted based on a link relation between Web pages.

37. The method according to claim 3, wherein
said regional meta-data is extracted based on past retrieval results of Web pages.

38. The method according to claim 3, wherein
said retrieval results are sorted according to the regional meta-data and location information.

39. The method according to claim 3, wherein
when the regional meta-data is assigned to the Web page by an author of the Web page, at least a part of the past retrieval results of the Web pages is presented.

40. The method according to claim 3, wherein
when a Web page is generated or updated, a candidate for the regional meta-data to be assigned to the Web page is extracted; and
said candidate for the regional meta-data is transmitted to an author of the Web page.

41. The method according to claim 3, wherein
advertisement information indicating contents to be advertised and the regional meta-data relating to the advertisement information are stored in a storage unit;
advertisement information having the regional meta-data relating to the location information is obtained from said storage unit; and
the obtained advertisement information is transmitted to a terminal which transmits the location information.

42. The method according to claim 2, wherein
said regional meta-data is extracted according to flag information indicating a location of a Web page in the Worldwide Web.

43. The method according to claim 2, wherein
said regional meta-data is extracted based on a link relation between Web pages.

44. The method according to claim 2, wherein
said regional meta-data is extracted based on past retrieval results of Web pages.

45. The method according to claim 2, wherein
said retrieval results are sorted according to the regional meta-data and location information.

46. The method according to claim 2, wherein
when the regional meta-data is assigned to the Web page by an author of the Web page, at least a part of the past retrieval results of the Web pages is presented.

47. The method according to claim 2, wherein
when a Web page is generated or updated, a candidate for the regional meta-data to be assigned to the Web page is extracted; and
said candidate for the regional meta-data is transmitted to an author of the Web page.

48. The method according to claim 2, wherein
advertisement information indicating contents to be advertised and the regional meta-data relating to the advertisement information are stored in a storage unit;
advertisement information having the regional meta-data relating to the location information is obtained from said storage unit; and
the obtained advertisement information is transmitted to a terminal which transmits the location information.

49. The method according to claim 1, wherein
said regional meta-data is extracted based on representation indicating a region contained in text of a Web page which is a linked page of another Web page.

50. The method according to claim 1, wherein
said regional meta-data is extracted according to flag information indicating a location of a Web page in the Worldwide Web.

51. The method according to claim 1, wherein
said regional meta-data is extracted based on a link relation between Web pages.

52. The method according to claim 1, wherein
said regional meta-data is extracted based on past retrieval results of Web pages.

53. The method according to claim 1, wherein
said retrieval results are sorted according to the regional meta-data and location information.

54. The method according to claim 1, wherein
when the regional meta-data is assigned to the Web page by an author of the Web page, at least a part of the past retrieval results of the Web pages is presented.

55. The method according to claim 1, wherein
when a Web page is generated or updated, a candidate for the regional meta-data to be assigned to the Web page is extracted; and
said candidate for the regional meta-data is transmitted to an author of the Web page.

56. The method according to claim 1, wherein
advertisement information indicating contents to be advertised and the regional meta-data relating to the advertisement information are stored in a storage unit;
advertisement information having the regional meta-data relating to the location information is obtained from said storage unit; and
the obtained advertisement information is transmitted to a terminal which transmits the location information.
